(19) United States
(12) Patent Application Publication
(10) Pub. No.: US 2025/0039800 A1
(43) Pub. Date: Jan. 30, 2025

(54) METHOD AND DEVICE FOR CONTROLLING UPLINK POWER IN WIRELESS COMMUNICATION SYSTEM

(71) Applicant: Samsung Electronics Co., Ltd., Suwon-si (KR)

(72) Inventors: Kyungjun CHOI, Suwon-si (KR); Younsun KIM, Suwon-si (KR); Jaeyeon SHIM, Suwon-si (KR); Hyoungju JI, Suwon-si (KR); Hyemin CHOE, Suwon-si (KR)

(21) Appl. No.: 18/770,155

(22) Filed: Jul. 11, 2024

(30) Foreign Application Priority Data
Jul. 11, 2023 (KR) 10-2023-0089509

(51) Int. Cl. H04W 52/14; H04W 52/28; H04W 52/36

(52) U.S. Cl. CPC H04W 52/146; H04W 52/281; H04W 52/367

(57) ABSTRACT

The disclosure relates to a fifth generation (5G) or sixth generation (6G) communication system for supporting a higher data rate. Further, the disclosure relates to an operation of a terminal and a base station in a wireless communication system. More specifically, the disclosure relates to a method in which a terminal transmits an uplink channel and a device capable of performing the same.

### CROSS-REFERENCE TO RELATED APPLICATION(S)

This application is based on and claims priority under 35 U.S.C. § 119(a) of a Korean patent application number 10-2023-0089509, filed on Jul. 11, 2023, in the Korean Intellectual Property Office, the disclosure of which is incorporated by reference herein in its entirety.

### BACKGROUND

### 1. Field

The disclosure relates to an operation of a terminal and a base station in a wireless communication system. More particularly, the disclosure relates to a method for a terminal to transmit an uplink channel and a device capable of performing the same.

### 2. Description of Related Art

Fifth generation (5G) mobile communication technology defines a wide frequency band to enable a fast transmission speed and new services, and may be implemented not only in a frequency (‘sub 6 gigahertz (GHz)’) band of 6 GHz or less such as 3.5 GHz, but also in an ultra high frequency band (‘above 6 GHz’) called a millimeter wave (mmWave) such as 28 GHz and 39 GHz. Further, in the case of sixth generation (6G) mobile communication technology, which is referred to as a beyond 5G system, in order to achieve a transmission speed that is 50 times faster than that of 5G mobile communication technology and ultra-low latency reduced to 1/10 compared to that of 5G mobile communication technology, implementations in terahertz bands (e.g., such as 95 GHz to 3 terahertz (3 THz) band) are being considered.

In the early days of 5G mobile communication technology, with the goal of satisfying the service support and performance requirements for an enhanced mobile broadband (eMBB), ultra-reliable low-latency communications (URLLC), and massive machine-type communications (mMTC), standardization has been carried out for beamforming and massive multiple-input multiple-output (MIMO) for mitigating a path loss of radio waves in an ultra-high frequency band and increasing a propagation distance of radio waves, support for various numerologies (multiple subcarrier spacing operation, and the like) for efficient use of ultra-high frequency resources and dynamic operation for slot formats, initial access technology for supporting multi-beam transmission and broadband, a definition and operation of a band-width part (BWP), a new channel coding method such as low density parity check (LDPC) code for large capacity data transmission and polar code for high reliable transmission of control information, L2 pre-processing, and network slicing that provides a dedicated network specialized for specific services.

Currently, discussions are ongoing to improve initial 5G mobile communication technology and enhance a performance thereof in consideration of services in which 5G mobile communication technology was intended to support, and physical layer standardization for technologies such as vehicle-to-everything (V2X) for helping driving determination of an autonomous vehicle and increasing user convenience based on a location and status information of the vehicle transmitted by the vehicle, new radio unlicensed (NR-U) for the purpose of a system operation that meets various regulatory requirements in unlicensed bands, NR user equipment (UE) power saving, a non-terrestrial network (NTN), which is direct UE-satellite communication for securing coverage in regions in which communication with a terrestrial network is impossible, and positioning is in progress.

Further, standardization in an air interface architecture/protocol field for technologies such as industrial Internet of things (IIoT) for supporting new services through linkage and convergence with other industries, integrated access and backhaul (IAB) that provides nodes for expanding network service regions by integrating wireless backhaul links and access links, mobility enhancement including conditional handover and dual active protocol stack (DAPS) handover, and 2-step RACH for NR that simplifies a random access procedure is also in progress, and standardization in a system architecture/service field for 5G baseline architecture (e.g., service based architecture, service based interface) for applying network functions virtualization (NFV) and software-defined networking (SDN) technologies, mobile edge computing (MEC) that receives services based on a location of a UE, and the like is also in progress.

When such a 5G mobile communication system is commercialized, connected devices in an explosive increase trend will be connected to communication networks; thus, it is expected that function and performance enhancement of a 5G mobile communication system and integrated operation of connected devices will be required. To this end, new research on extended reality (XR) for efficiently supporting augmented reality (AR), virtual reality (VR), mixed reality (MR), and the like, 5G performance improvement and complexity reduction using artificial intelligence (AI) and machine learning (ML), AI service support, metaverse service support, and drone communication will be conducted.

Further, the development of such a 5G mobile communication system will be the basis for the development of full duplex technology for improving frequency efficiency and system network of 6G mobile communication technology, satellite, AI-based communication technology that utilizes artificial intelligence (AI) from a design stage and that realizes system optimization by internalizing end-to-end AI support functions, and next generation distributed computing technology that realizes complex services beyond the limits of UE computing capabilities by utilizing ultra-high-performance communication and computing resources as well as a new waveform for ensuring coverage in a terahertz band of 6G mobile communication technology, full dimensional MIMO (FD-MIMO), multi-antenna transmission technologies such as an array antenna and large scale antenna, metamaterial-based lenses and antennas for improving coverage of terahertz band signals, high-dimensional spatial multiplexing technology using orbital angular momentum (OAM), and reconfigurable intelligent surface (RIS) technology.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and method that can effectively provide a service in a mobile communication system.

Additional aspects will be set forth in part in the description which follows and, in part, will be apparent from the description, or may be learned by practice of the presented embodiments.

In accordance with an aspect of the disclosure, a method performed by a user equipment (UE) in a communication system is provided. The method includes receiving, from a base station, information for a downlink channel or a downlink signal, receiving, from the base station, information for an uplink channel or an uplink signal, determining transmission power for the uplink channel or the uplink signal, and transmitting, to the base station, the uplink channel or the uplink signal based on the transmission power, wherein the transmission power for the uplink channel or the uplink signal is determined as a first transmission power in case that the downlink channel or the downlink signal does not overlap with the uplink channel or the uplink signal, wherein the transmission power for the uplink channel or the uplink signal is determined as a second transmission power in case that the downlink channel or the downlink signal overlaps with the uplink channel or the uplink signal, and wherein the second transmission power is less than or equal to the first transmission power.

In accordance with another aspect of the disclosure, a user equipment (UE) in a communication system is provided. The UE includes a transceiver and a controller configured to receive, from a base station, information for a downlink channel or a downlink signal, receive, from the base station, information for an uplink channel or an uplink signal, determine transmission power for the uplink channel or the uplink signal, and transmit, to the base station, the uplink channel or the uplink signal based on the transmission power, wherein the transmission power for the uplink channel or the uplink signal is determined as a first transmission power in case that the downlink channel or the downlink signal does not overlap with the uplink channel or the uplink signal, wherein the transmission power for the uplink channel or the uplink signal is determined as a second transmission power in case that the downlink channel or the downlink signal overlaps with the uplink channel or the uplink signal, and wherein the second transmission power is less than or equal to the first transmission power.

In accordance with another aspect of the disclosure, a method performed by a base station in a communication system is provided. The method includes transmitting, to a user equipment (UE), information for a downlink channel or a downlink signal, transmitting, to the UE, information for an uplink channel or an uplink signal, and receiving, from the UE, the uplink channel or the uplink signal associated with a transmission power for the uplink channel or the uplink signal, wherein the transmission power for the uplink channel or the uplink signal is a first transmission power in case that the downlink channel or the downlink signal does not overlap with the uplink channel or the uplink signal, wherein the transmission power for the uplink channel or the uplink signal is a second transmission power in case that the downlink channel or the downlink signal overlaps with the uplink channel or the uplink signal, and wherein the second transmission power is less than or equal to the first transmission power.

In accordance with another aspect of the disclosure, a base station in a communication system is provided. The base station includes a transceiver and a controller configured to transmit, to a user equipment (UE), information for a downlink channel or a downlink signal, transmit, to the UE, information for an uplink channel or an uplink signal, and receive, from the UE, the uplink channel or the uplink signal associated with a transmission power for the uplink channel or the uplink signal, wherein the transmission power for the uplink channel or the uplink signal is a first transmission power in case that the downlink channel or the downlink signal does not overlap with the uplink channel or the uplink signal, wherein the transmission power for the uplink channel or the uplink signal is a second transmission power in case that the downlink channel or the downlink signal overlaps with the uplink channel or the uplink signal, wherein the second transmission power is less than or equal to the first transmission power.

The disclosed embodiment can provide a device and method that can effectively provide a service in a mobile communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a basic structure of a time-frequency domain in a wireless communication system according to an embodiment of the disclosure;

FIG. 2 is a diagram illustrating a frame, subframe, and slot structure in a wireless communication system according to an embodiment of the disclosure;

FIG. 3 is a diagram illustrating an example of a bandwidth part configuration in a wireless communication system according to an embodiment of the disclosure;

FIG. 4 is a diagram illustrating an example of a control area configuration of a downlink control channel in a wireless communication system according to an embodiment of the disclosure;

FIG. 5 is a diagram illustrating a structure of a downlink control channel in a wireless communication system according to an embodiment of the disclosure;

FIG. 6 is a diagram illustrating a method in which a base station and a terminal transmit and receive data in consideration of a physical downlink shared channel and rate matching resource in a wireless communication system according to an embodiment of the disclosure;

FIG. 7 is a diagram illustrating an example of frequency axis resource assignment of a PDSCH in a wireless communication system according to an embodiment of the disclosure;

FIG. 8 is a diagram illustrating an example of time axis resource assignment of a PDSCH in a wireless communication system according to an embodiment of the disclosure;

FIG. 9 is a diagram illustrating an example of time axis resource assignment according to subcarrier spacing of a data channel and a control channel in a wireless communication system according to an embodiment of the disclosure;

FIG. 10 is a block diagram illustrating a wireless protocol structure of a base station and a terminal in a single cell, carrier aggregation, and dual connectivity situation in a wireless communication system according to an embodiment of the disclosure;

FIG. 11 is a diagram illustrating a TDD configuration and SBFD configuration according to an embodiment of the disclosure;

FIG. 12 is a diagram illustrating an SBFD configuration according to an embodiment of the disclosure;

FIG. 13 is a diagram illustrating a scenario in which UE-UE CLI occurs according to an embodiment of the disclosure;

FIG. 14 is a diagram illustrating an SSB configuration and PUSCH transmission in a cell in which an SBFD operation is configured according to an embodiment of the disclosure;

FIG. 15 is a diagram illustrating an RACH occasion (RO) configuration and PDSCH transmission in a cell in which an SBFD operation is configured according to an embodiment of the disclosure;

FIGS. 16 and 17 are diagrams illustrating PUSCH repetition transmission according to various embodiments of the disclosure;

FIG. 18 is a flowchart according to an embodiment of the disclosure;

FIG. 19 is a flowchart according to an embodiment of the disclosure;

FIG. 20 is a flowchart according to an embodiment of the disclosure;

FIG. 21 is a block diagram illustrating a structure of a terminal in a wireless communication system according to an embodiment of the disclosure; and

FIG. 22 is a block diagram illustrating a structure of a base station in a wireless communication system according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing embodiments, descriptions of technical contents that are well known in the technical field to which the disclosure pertains and that are not directly related to the disclosure will be omitted. This is to more clearly convey the gist of the disclosure without obscuring the gist of the disclosure by omitting unnecessary description.

For the same reason, some components are exaggerated, omitted, or schematically illustrated in the accompanying drawings. Further, the size of each component does not fully reflect the actual size. In each drawing, the same reference numerals are given to the same or corresponding components.

Advantages and features of the disclosure, and a method of achieving them will become apparent with reference to the embodiments described below in detail in conjunction with the accompanying drawings. However, the disclosure is not limited to the embodiments disclosed below, but may be implemented in various different forms, and only embodiments of the disclosure enable the disclosure to be complete, and are provided to fully inform the scope of the disclosure to those of ordinary skill in the art to which the disclosure belongs, and the disclosure is only defined by the scope of the claims. Like reference numerals refer to like components throughout the specification. Further, in describing the disclosure, in the case that it is determined that a detailed description of a related function or constitution may unnecessarily obscure the gist of the disclosure, a detailed description thereof will be omitted. Terms described below are terms defined in consideration of functions in the disclosure, which may vary according to intentions or customs of users and operators. Therefore, the definition should be made based on the content throughout this specification.

Hereinafter, a base station is a subject performing resource allocation of a terminal, and may be at least one of a gNode B, an eNode B, a node B, a base station (BS), a radio access unit, a base station controller, or a node on a network. The terminal may include a user equipment (UE), a mobile station (MS), a cellular phone, a smart phone, a computer, or a multimedia system capable of performing a communication function. In the disclosure, a downlink (DL) is a wireless transmission path of a signal transmitted from a base station to a terminal, and an uplink (UL) is a wireless transmission path of a signal transmitted from a terminal to a base station. Hereinafter, although long term evolution (LTE) or LTE-Advanced (LTE-A) system may be described as an example, embodiments of the disclosure may be applied to other communication systems having a similar technical background or channel type. For example, 5G mobile communication technology (5G, new radio (NR)) developed after LTE-A may be included therein, and the following 5G may be a concept including existing LTE, LTE-A and other similar services. Further, the disclosure may be applied to other communication systems through some modifications within a range that does not significantly deviate from the scope of the disclosure by the determination of a person having skilled technical knowledge.

In this case, it will be understood that each block of flowcharts and combinations of the flowcharts may be performed by computer program instructions. Because these computer program instructions may be mounted in a processor of a general purpose computer, a special purpose computer, or other programmable data processing equipment, instructions performed by a processor of a computer or other programmable data processing equipment generate a means that performs functions described in the flowchart block(s). Because these computer program instructions may be stored in computer usable or computer readable memory that may direct a computer or other programmable data processing equipment in order to implement a function in a particular manner, the instructions stored in the computer usable or computer readable memory may produce a production article containing instruction means for performing the function described in the flowchart block(s). Because the computer program instructions may be mounted on a computer or other programmable data processing equipment, a series of operation steps are performed on the computer or other programmable data processing equipment to generate a computer-executed process; thus, instructions for performing the computer or other programmable data processing equipment may provide steps for performing functions described in the flowchart block(s).

Further, each block may represent a portion of a module, a segment, or a code including one or more executable instructions for executing a specified logical function(s). Further, it should be noted that in some alternative implementations, functions recited in the blocks may occur out of order. For example, two blocks illustrated one after another may in fact be performed substantially simultaneously, or the blocks may be sometimes performed in the reverse order according to the corresponding function.

In this case, a term ‘-unit’ used in this embodiment means software or hardware components such as a field programmable gate array (FPGA) or an application specific integrated circuit (ASIC), and ‘-unit’ performs certain roles. However, ‘-unit’ is not limited to software or hardware. ‘-unit’ may be constituted to reside in an addressable storage medium or may be constituted to reproduce one or more processors. Therefore, as an example, ‘-unit’ includes components such as software components, object-oriented software components, class components, and task components, processes, functions, properties, procedures, subroutines, segments of program code, drivers, firmware, microcode, circuit, data, databases, data structures, tables, arrays, and variables. Functions provided in the components and ‘-units’ may be combined into a smaller number of components and ‘-units’ or may be further separated into additional components and ‘-units’. Further, components and ‘-units’ may be implemented to reproduce one or more central processing units (CPUs) in a device or secure multimedia card. Further, in an embodiment, ‘-unit’ may include one or more processors.

A wireless communication system is evolving from providing voice-oriented services in the early days to a broadband wireless communication system that provides high-speed and high-quality packet data services as in communication standards such as high speed packet access (HSPA), long term evolution (LTE) or evolved universal terrestrial radio access (E-UTRA), LTE-Advanced (LTE-A), and LTE-Pro of 3GPP, high rate packet data (HRPD) and ultra mobile broadband (UMB) of 3GPP2, and IEEE 802.16e.

An LTE system, which is a representative example of the broadband wireless communication system, employs an orthogonal frequency division multiplexing (OFDM) scheme in a downlink (DL) and a single carrier frequency division multiple access (SC-FDMA) scheme in an uplink. The uplink means a radio link in which a user equipment (UE) or a mobile station (MS) transmits data or control signals to an eNode B (eNB) or a base station (BS), and the downlink means a radio link in which a base station transmits data or control signals to a terminal. The above-described multiple access method enables data or control information of each user to distinguish by allocating and operating data or control information so that time-frequency resources to carry data or control information for each user in general do not overlap each other, that is, so that orthogonality is established.

A 5G communication system, which is a future communication system after LTE, should support services that simultaneously satisfy various requirements so that various requirements of users and service providers may be freely reflected. Services considered for the 5G communication system include enhanced mobile broadband (eMBB), massive machine type communication (mMTC), ultra reliability low latency communication (URLLC), and the like.

The eMBB aims to provide a more improved data rate than a data rate supported by existing LTE, LTE-A, or LTE-Pro. For example, in the 5G communication system, the eMBB should be able to provide a peak data rate of 20 Gbps in a downlink and a peak data rate of 10 Gbps in an uplink from the viewpoint of one base station. Further, the 5G communication system should provide an increased user perceived data rate of a terminal while providing a peak data rate. In order to satisfy such requirements, it is required to improve various transmission and reception technologies, including more advanced multi input and multi output (MIMO) transmission technology. Further, the LTE system transmits a signal using a transmission bandwidth of maximum 20 MHz in the 2 GHz band, whereas the 5G communication system can satisfy a data rate required by the same by using a frequency bandwidth wider than 20 MHz in a frequency band of 3 to 6 GHz or 6 GHz or more.

At the same time, in the 5G communication system, mMTC is being considered to support application services such as Internet of Thing (IoT). In order to efficiently provide IoT, mMTC requires access support for large-scale terminals within a cell, improvement of coverage of terminals, an improved battery time, and cost reduction of terminals. Because the IoT is attached to various sensors and various devices to provide communication functions, it should be able to support a large number of terminals (e.g., 1,000,000 terminals/km²) within a cell. Further, because a terminal supporting mMTC is likely to be located in a shaded area that a cell cannot cover, such as the basement of a building, due to the nature of the service, the terminal may require wider coverage compared to other services provided by the 5G communication system. The terminal supporting mMTC should be composed of a low cost terminal, and because it is difficult to frequently exchange a battery of the terminal, a very long battery life time such as 10 to 15 years may be required.

Finally, URLLC is a cellular-based wireless communication service used for mission-critical. For example, a service used for remote control of a robot or machinery, industrial automation, unmanned aerial vehicle, remote health care, emergency alert, and the like may be considered. Therefore, communication provided by URLLC should provide very low latency and very high reliability. For example, a service supporting URLLC should satisfy air interface latency smaller than 0.5 milliseconds and simultaneously has the requirement of a packet error rate of 10-5 or less. Therefore, for a service supporting URLLC, the 5G system may require design requirements that should provide a transmit time interval (TTI) smaller than that of other services and that should simultaneously allocate a wide resource in a frequency band in order to secure reliability of a communication link.

Three services, i.e., eMBB, URLLC, and mMTC of 5G may be multiplexed and transmitted in a single system. In this case, in order to satisfy different requirements of each service, different transmission and reception techniques and transmission and reception parameters may be used between services. 5G is not limited to the above-described three services.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

### NR Time-Frequency Resource

Hereinafter, a frame structure of a 5G system will be described in more detail with reference to the drawings.

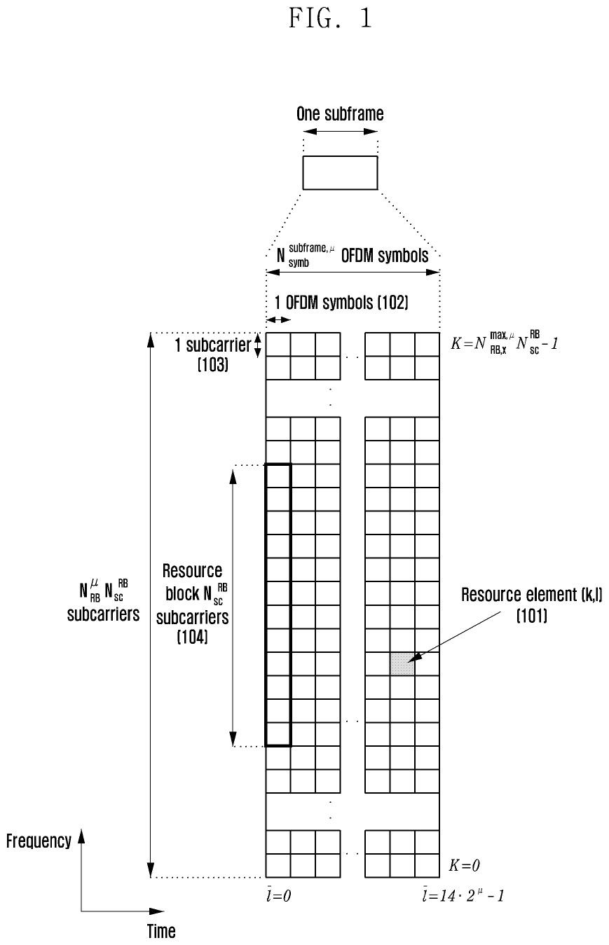

FIG. 1 is a diagram illustrating a basic structure of a time-frequency domain, which is a radio resource domain in which a data or control channel is transmitted in a 5G system according to an embodiment of the disclosure.

Referring to FIG. 1, a horizontal axis of FIG. 1 represents a time domain, and a vertical axis of FIG. 1 represents a frequency domain. A basic unit of resources in the time and frequency domains is a resource element (RE) 101 and may be defined to 1 orthogonal frequency division multiplexing (OFDM) symbol 102 on the time axis and 1 subcarrier 103 on the frequency axis. In the frequency domain, the N_{SC}^{RB} (e.g., 12) number of consecutive REs may constitute one resource block (RB) 104.

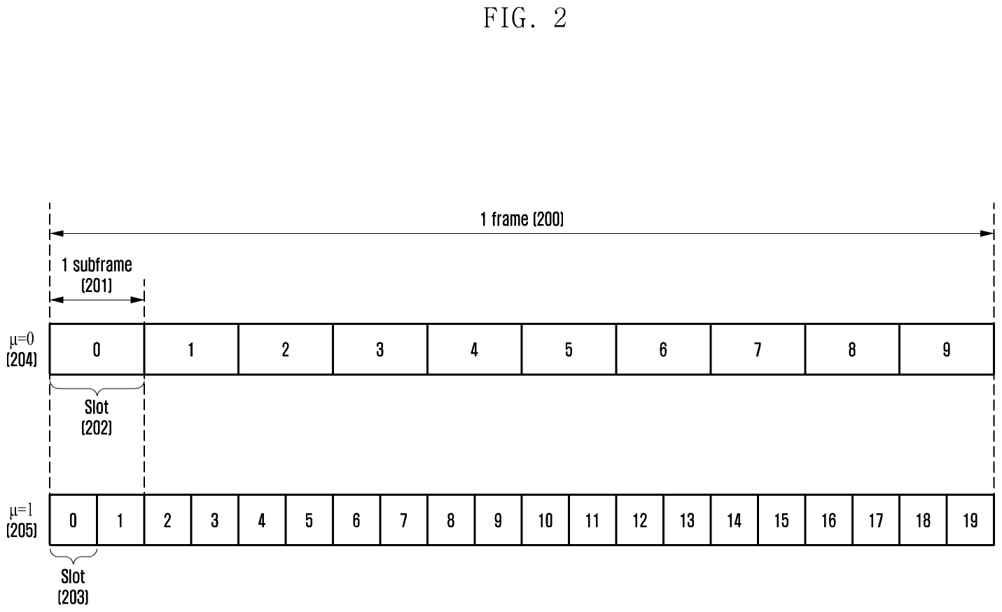

FIG. 2 is a diagram illustrating a frame, subframe, and slot structure in a wireless communication system according to an embodiment of the disclosure.

Referring to FIG. 2, an example of a structure of a frame 200, a subframe 201, and a slot 202 is illustrated. 1 frame 200 may be defined to 10 milliseconds (ms). 1 subframe 201 may be defined to 1 ms; thus, 1 frame 200 may be composed of total 10 subframes 201. 1 slot 202 and 1 slot 203 may be defined to 14 OFDM symbols (i.e., the number N_{symb}^{slot} of symbols per slot is 14). 1 subframe 201 may be composed of one or a plurality of slots 202 and 203, and the number of slots 202 and 203 per subframe 201 may vary according to configuration values μ 204 and μ 205 for subcarrier spacing. In an example of FIG. 2, the case that μ=0, (e.g., μ204) and the case that μ=1, (e.g., μ205) are illustrated as the subcarrier spacing configuration value. In the case that μ=0, (e.g., μ 204,) 1 subframe 201 may be composed of 1 slot 202, and in the case that μ=1, (e.g., μ 205), 1 subframe 201 may be composed of 2 slots 203. That is, the number Nₛₗₒₜ^{subframe,μ} of slots per subframe may vary according to the configuration value μ for the subcarrier spacing; thus, the number Nₛₗₒₜ^{frame,μ} of slots per frame may vary. Nₛₗₒₜ^{subframe,μ} and Nₛₗₒₜ^{frame,μ} according to each subcarrier spacing configuration u may be defined in Table 1.

TABLE 1

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### Bandwidth Part (BWP)

Hereinafter, a bandwidth part (BWP) configuration in a 5G communication system will be described in detail with reference to the drawings.

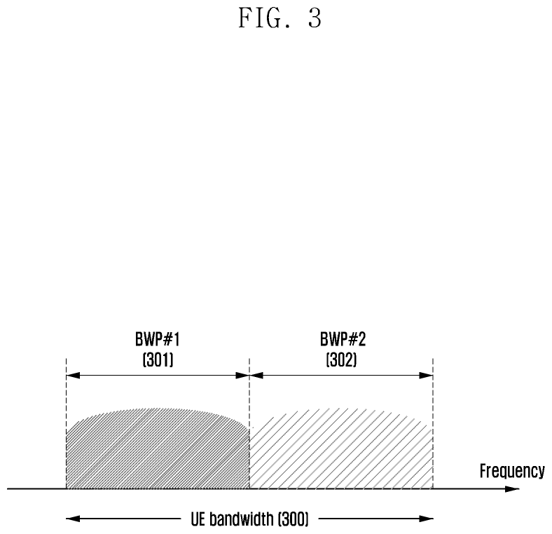

FIG. 3 is a diagram illustrating an example of a bandwidth part configuration in a wireless communication system according to an embodiment of the disclosure.

Referring to FIG. 3, an example in which a UE bandwidth 300 is configured to two bandwidth parts (BWPs), that is, a BWP #1 301 and a BWP #2 302, is illustrated. The base station may configure one or a plurality of bandwidth parts to the UE and configure information such as Table 2 for each bandwidth part.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, |

n4, n5},
(subcarrier spacing)

| | |
|---|---|
| cyclicPrefix | ENUMERATED { extended } |

(cyclic prefix)
}

The disclosure is not limited to the above example, and various parameters related to the bandwidth part in addition to the configuration information may be configured to the UE. The information may be transmitted by the base station to the UE through higher layer signaling, for example, radio resource control (RRC) signaling. At least one bandwidth part among one or a plurality of configured bandwidth parts may be activated. Whether the configured bandwidth part is activated may be semi-statically transmitted from the base station to the UE through RRC signaling or may be dynamically transmitted from the base station to the UE through downlink control information (DCI).

According to some embodiments, the UE before RRC connection may receive a configuration of an initial BWP for initial access from the base station through a master information block (MIB). More specifically, in an initial access step, the UE may receive configuration information on a search space and a control resource set (CORESET) in which a PDCCH for receiving system information (may correspond to remaining system information (RMSI) or system information block 1 (SIB1)) necessary for initial access may be transmitted through the MIB. The CORESET and search space configured by the MIB may be regarded as an identity (ID) 0, respectively. The base station may notify the UE of configuration information such as frequency allocation information, time allocation information, and numerology for the CORESET #0 through the MIB. Further, the base station may notify the UE of configuration information on a monitoring period and occasion for the CORESET #0, that is, configuration information on a search space #0 through the MIB. The UE may regard a frequency domain configured to the CORESET #0 acquired from the MIB as an initial bandwidth part for initial access. In this case, an identifier (ID) of the initial bandwidth part may be regarded as 0.

A configuration for the bandwidth part supported in the 5G may be used for various purposes.

According to some embodiments, in the case that a bandwidth supported by the UE is smaller than the system bandwidth, this may be supported through the bandwidth part configuration. For example, as the base station configures a frequency location (configuration information 2) of the bandwidth part to the UE, the UE may transmit and receive data at a specific frequency location within the system bandwidth.

Further, according to some embodiments, for the purpose of supporting different numerologies, the base station may configure a plurality of bandwidth parts to the UE. For example, in order to support both data transmission and reception using subcarrier spacing of 15 kilohertz (kHz) and subcarrier spacing of 30 kHz to a certain UE, the base station may configure two bandwidth parts to subcarrier spacings of 15 kHz and 30 kHz, respectively. Different bandwidth parts may be frequency division multiplexed, and in the case that data is to be transmitted and received at specific subcarrier spacing, a bandwidth part configured at corresponding subcarrier spacing may be activated.

Further, according to some embodiments, for the purpose of reducing power consumption of the UE, the base station may configure bandwidth parts having different sizes of bandwidth to the UE. For example, in the case that the UE supports a very large bandwidth, for example, a bandwidth of 100 megahertz (MHz) and always transmits and receives data with the corresponding bandwidth, very large power consumption may occur. In particular, monitoring an unnecessary downlink control channel with a large bandwidth of 100 MHz in a situation in which there is no traffic may be very inefficient in terms of power consumption. For the purpose of reducing power consumption of the UE, the base station may configure a bandwidth part of a relatively small bandwidth, for example, a bandwidth part of 20 MHz to the UE. In a situation in which there is no traffic, the UE may perform a monitoring operation in the bandwidth part of 20 MHz, and in the case that data is generated, the UE may transmit and receive data with the bandwidth part of 100 MHz according to the instruction of the base station.

In a method of configuring the bandwidth part, UEs before RRC connection may receive configuration information on the initial bandwidth part through an MIB in an initial access step. More specifically, the UE may receive a configuration of a control resource set (CORESET) for a downlink control channel in which DCI scheduling a system information block (SIB) may be transmitted from the MIB of a physical broadcast channel (PBCH). A bandwidth of the CORESET configured by the MIB may be regarded as an initial bandwidth part, and the UE may receive a physical downlink shared channel (PDSCH) in which the SIB is transmitted through the configured initial bandwidth part. The initial bandwidth part may be used for other system information (OSI), paging, and random access in addition to the use of receiving the SIB.

### Bandwidth Part (BWP) Change

In the case that one or more bandwidth parts are configured to the UE, the base station may instruct the UE to change (or switch, transition) the bandwidth part using a BWP indicator field in the DCI. For example, in FIG. 3, in the case that the currently activated BWP of the UE is a BWP #1 301, the base station may indicate a BWP #2 302 with a BWP indicator in the DCI to the UE, and the UE may perform the BWP change with the BWP #2 302 indicated by the BWP indicator in the received DCI.

As described above, because the DCI-based bandwidth part change may be indicated by DCI scheduling the PDSCH or PUSCH, in the case that the UE receives the bandwidth part change request, the UE should receive or transmit the PDSCH or PUSCH scheduled by the corresponding DCI in the changed bandwidth part without difficulty. To this end, the standard stipulates the requirements for a delay time TBWP required when changing the bandwidth part, and may be defined, for example, as in Table 3.

TABLE 3

| | NR Slot | BWP switch delay TBWP (slots) | |
|---|---|---|---|
| μ | length (ms) | Type 1Note 1 | Type 2Note 1 |
| 0 | 1 | 1 | 3 |
| 1 | 0.5 | 2 | 5 |
| 2 | 0.25 | 3 | 9 |
| 3 | 0.125 | 6 | 18 |

Note 1:
Depends on UE capability.
Note 2:
If the BWP switch involves changing of SCS, the BWP switch delay is determined by the larger one between the SCS before BWP switch and the SCS after BWP switch.

The requirement for a bandwidth part change delay time supports a type 1 or type 2 according to a capability of the UE. The UE may report a supportable bandwidth part delay time type to the base station.

According to the requirement for the bandwidth part change delay time, in the case that the UE receives DCI including a bandwidth part change indicator in a slot n, the UE may complete the change to a new bandwidth part indicated by the bandwidth part change indicator at a time point not later than a slot n+T_{BWP} and perform transmission and reception for a data channel scheduled by the corresponding DCI in the changed new bandwidth part. In the case that the base station wants to schedule a data channel with a new bandwidth part, the base station may determine time domain resource allocation for the data channel in consideration of the bandwidth part change delay time T_{BWP} of the UE. That is, when scheduling a data channel with a new bandwidth part, in a method of determining time domain resource allocation for the data channel, the base station may schedule the corresponding data channel after the bandwidth part change delay time. Accordingly, the UE may not expect that DCI indicating the bandwidth part change indicates a slot offset value (K0 or K2) smaller than the bandwidth part change delay time T_{BWP}.

When the UE receives DCI (e.g., DCI format 1_1 or 0_1) indicating a change in bandwidth part, the UE may not perform any transmission or reception during a corresponding time interval from a third symbol of a slot that receives a PDCCH including the corresponding DCI to a start point of a slot indicated by a slot offset value (K0 or K2) indicated by a time domain resource allocation indicator field in the corresponding DCI. For example, when the UE received DCI indicating a bandwidth part change in a slot n, and a slot offset value indicated by the corresponding DCI is K, the UE may not perform any transmission or reception from a third symbol of the slot n to the previous symbol of a slot n+K (i.e., a last symbol of a slot n+K−1).

### SS/PBCH Block

Hereinafter, a synchronization signal (SS)/PBCH block in 5G will be described.

The SS/PBCH block may mean a physical layer channel block composed of a primary SS (PSS), a secondary SS (SSS), and a PBCH. Specifically, it is as follows.
PSS: The PSS is a reference signal for downlink time/frequency synchronization and provides some information of a cell ID.
SSS: The SSS is a reference for downlink time/frequency synchronization and provides remaining cell ID information that is not provided by the PSS. Additionally, the SSS may serve as a reference signal for demodulation of a PBCH.
PBCH: The PBCH provides essential system information required for transmission and reception of a data channel and a control channel of the UE. Essential system information may include search space related control information indicating radio resource mapping information of a control channel, scheduling control information on a separate data channel that transmits system information, and the like.
SS/PBCH block: The SS/PBCH block is composed of a combination of the PSS, SSS, and PBCH. One or a plurality of SS/PBCH blocks may be transmitted within a time of 5 ms, and each transmitted SS/PBCH block may be distinguished by an index.

The UE may detect the PSS and SSS in an initial access step and decode the PBCH. The MIB may be acquired from the PBCH, and a control resource set (CORESET) #0 (which may correspond to a CORESET having a CORESET index of 0) may be configured therefrom. The UE may assume that the selected SS/PBCH block and a demodulation reference signal (DMRS) transmitted in the CORESET #0 are quasi co-located (QCL) and perform monitoring for the CORESET #0. The UE may receive system information with downlink control information transmitted in the CORESET #0. The UE may acquire random access channel (RACH) related configuration information required for initial access from the received system information. The UE may transmit a physical RACH (PRACH) to the base station in consideration of the selected SS/PBCH index, and the base station that has received the PRACH may acquire information on the SS/PBCH block index selected by the UE. The base station may know that the UE has selected a certain block among SS/PBCH blocks and monitors the CORESET #0 related thereto.

### PDCCH: Related to DCI

Hereinafter, downlink control information (DCI) in a 5G system will be described in detail.

In the 5G system, scheduling information on uplink data (or physical uplink shared channel (PUSCH)) or downlink data (or physical downlink shared channel (PDSCH)) is transmitted from the base station to the UE through DCI. The UE may monitor a DCI format for fallback and a DCI format for non-fallback with respect to the PUSCH or PDSCH. The DCI format for fallback may be composed of a fixed field predefined between the base station and the UE, and the DCI format for non-fallback may include a configurable field.

The DCI may be transmitted through a physical downlink control channel (PDCCH) via channel coding and modulation processes. A cyclic redundancy check (CRC) is attached to a DCI message payload, and the CRC may be scrambled with a radio network temporary identifier (RNTI) corresponding to the identity of the UE. Different RNTIs may be used according to the purpose of the DCI message, for example, UE-specific data transmission, power control command, or random access response. That is, the RNTI is not explicitly transmitted but is included in a CRC calculation process and transmitted. Upon receiving the DCI message transmitted on the PDCCH, the UE may identify the CRC using the allocated RNTI, and when the CRC identification result is correct, the UE may know that the corresponding message has been transmitted to the UE.

For example, DCI scheduling a PDSCH for system information (SI) may be scrambled with an SI-RNTI. DCI scheduling a PDSCH for a random access response (RAR) message may be scrambled with an RA-RNTI. DCI scheduling a PDSCH for a paging message may be scrambled with a P-RNTI. DCI notifying a slot format indicator (SFI) may be scrambled with an SFI-RNTI. DCI notifying transmit power control (TPC) may be scrambled with a TPC-RNTI. DCI scheduling a UE-specific PDSCH or PUSCH may be scrambled with a cell RNTI (C-RNTI).

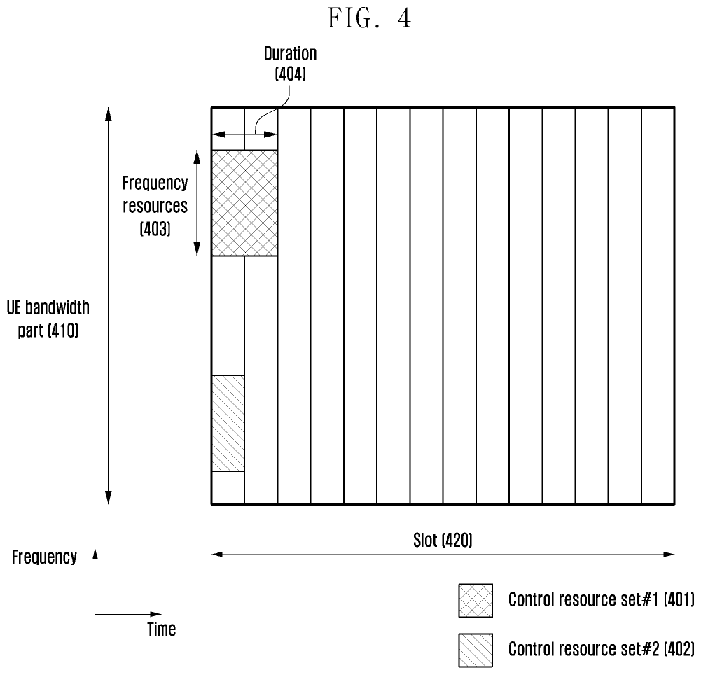

A DCI format 0_0 may be used as fallback DCI scheduling a PUSCH, and in this case, a CRC may be scrambled with a C-RNTI. The DCI format 0_0 in which a CRC is scrambled with a C-RNTI may include, for example, information of FIG. 4.

TABLE 4

| | |
|---|---|
| - | Identifier for DCI formats - [1] bit |
| - | Frequency domain resource assignment-[┌log₂(N_{RB}^{UL,BWP}(N_{RB}^{UL,BWP} +1)/2)┐] bits |
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | TPC command for scheduled PUSCH - [2] bits |
| - | UL/SUL (supplementary UL) indicator - 0 or 1 bit |

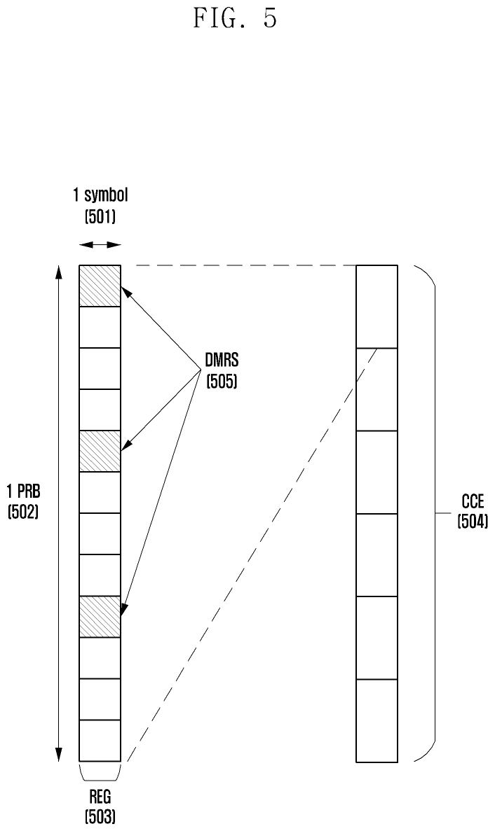

A DCI format 0_1 may be used as non-fallback DCI scheduling a PUSCH, and in this case, a CRC may be scrambled with a C-RNTI. The DCI format 0_1 in which a CRC is scrambled with a C-RNTI may include, for example, information of FIG. 5.

TABLE 5

| | |
|---|---|
| - | Carrier indicator - 0 or 3 bits |
| - | UL/SUL indicator - 0 or 1 bit |
| - | Identifier for DCI formats - [1] bits |
| - | Bandwidth part indicator - 0, 1 or 2 bits |
| - | Frequency domain axis assignment |

For resource allocation type 0, ┌N_{RB}^{UL,BWP}/P┐ bits
For resource allocation type 1, ┌log₂(N_{RB}^{UL,BWP}(N_{RB}^{UL,BWP} +1)/2)┐

| | |
|---|---|
| - | Time domain resource assignment -1, 2, 3, or 4 bits |
| - | VRB (virtual resource block)-to-PRB (physical resource block) |
| | mapping - 0 |

or 1 bit, only for resource allocation type 1.
0 bit if only resource allocation type 0 is configured;
1 bit otherwise.

| | |
|---|---|
| - | Frequency hopping flag - 0 or 1 bit, only for resource allocation type 1. |

0 bit if only resource allocation type 0 is configured;
1 bit otherwise.

| | |
|---|---|
| - | Modulation and coding scheme - 5 bits |
| - | New data indicator - 1 bit |
| - | Redundancy version - 2 bits |
| - | HARQ process number - 4 bits |
| - | 1st downlink assignment index- 1 or 2 bits |

1 bit for semi-static HARQ-ACK codebook;
2 bits for dynamic HARQ-ACK codebook with single HARQ-ACK
codebook.

| | |
|---|---|
| - | 2nd downlink assignment index - 0 or 2 bits |

2 bits for dynamic HARQ-ACK codebook with two HARQ-ACK sub-
codebooks;
0 bit otherwise.

| | |
|---|---|
| - | TPC command for scheduled PUSCH - 2 bits |
| - | $SRS resource indicator ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$ |
| | $⌈ {log}_{2} ( {\sum }_{k = 1}^{{L}_{max}} ( \begin{matrix}{N}_{SRS} \\ k\end{matrix} ) ) ⌉ bits for \text{non-codebook} based PUSCH transmission ;$ |
| | ┌log₂(N_{SRS})┐ bits for codebook based PUSCH transmission. |
| - | Precoding information and number of layers -up to 6 bits |
| - | Antenna ports- up to 5 bits |
| - | SRS request - 2 bits |
| - | CSI request - 0, 1, 2, 3, 4, 5, or 6 bits |
| - | CBG (code block group) transmission information - 0, 2, 4, 6, or 8 bits |
| - | PTRS-DMRS association - 0 or 2 bits. |
| - | beta_offset indicator - 0 or 2 bits |
| - | DMRS sequence initialization - 0 or 1 bit |

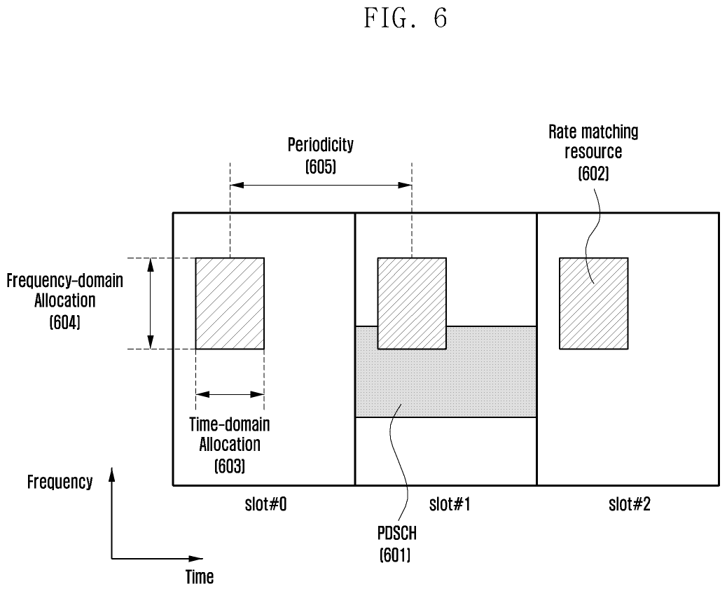

A DCI format 1_0 may be used as fallback DCI scheduling a PDSCH, and in this case, a CRC may be scrambled with a C-RNTI. The DCI format 1_0 in which a CRC is scrambled with a C-RNTI may include, for example, information of FIG. 6.

TABLE 6

| | |
|---|---|
| - | Identifier for DCI formats - [1] bit |
| - | Frequency domain resource assignment -[┌log₂(N_{RB}^{DL,BWP}(N_{RB}^{DL,BWP} + |

1)/2)┐] bits

| | |
|---|---|
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | PUCCH (physical uplink control channel) resource indicator - 3 bits |
| - | PDSCH-to-HARQ feedback timing indicator - [3] bits |

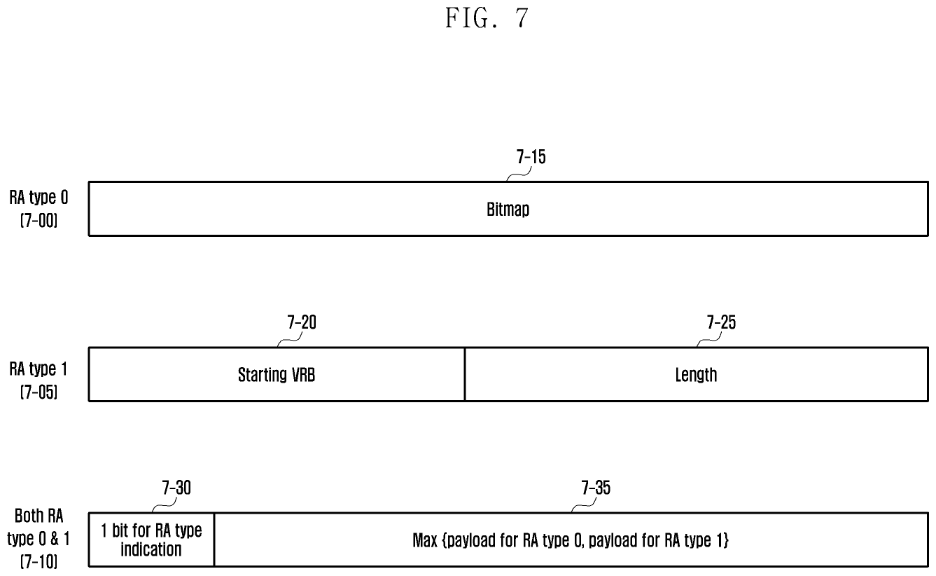

A DCI format 1_1 may be used as non-fallback DCI scheduling a PDSCH, and in this case, a CRC may be scrambled with a C-RNTI. The DCI format 1_1 in which a CRC is scrambled with a C-RNTI may include, for example, information of FIG. 7.

TABLE 7

| | |
|---|---|
| - | Carrier indicator - 0 or 3 bits |
| - | Identifier for DCI formats - [1] bits |
| - | Bandwidth part indicator - 0, 1 or 2 bits |
| - | Frequency domain resource assignment |

For resource allocation type 0, ┌N_{RB}^{DL,BWP} / P┐bits
For resource allocation type 1, ┌log₂(N_{RB}^{DL,BWP}(N_{RB}^{DL,BWP} +1)/2)┐ bits

| | |
|---|---|
| - | Time domain resource assignment -1, 2, 3, or 4 bits |
| - | VRB-to-PRB mapping - 0 or 1 bit, only for resource allocation type 1. |

0 bit if only resource allocation type 0 is configured;
1 bit otherwise.

| | |
|---|---|
| - | PRB bundling size indicator - 0 or 1 bit |
| - | Rate matching indicator - 0, 1, or 2 bits |
| - | ZP CSI-RS trigger - 0, 1, or 2 bits |

For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

### PDCCH: CORESET, REG, CCE, Search Space

Hereinafter, a downlink control channel in a 5G communication system will be described in more detail with reference to the drawings.

FIG. 4 is a diagram illustrating an example of a control area (control resource set (CORESET)) in which a downlink control channel is transmitted in a 5G wireless communication system according to an embodiment of the disclosure.

Referring to FIG. 4, an example in which a UE bandwidth part 410 is configured on the frequency axis and in which two CORESETs (CORESET #1, 401 and CORESET #2, 402) are configured within 1 slot 420 on the time axis, is illustrated. The CORESETs 401 and 402 may be configured to a specific frequency resource 403 within the entire UE bandwidth part 410 on the frequency axis. One or a plurality of OFDM symbols may be configured to the time axis, and this may be defined to a control resource set duration 404. With reference to the illustrated example of FIG. 4, a CORESET #1, 401 is configured to a control resource set duration of 2 symbols, and a CORESET #2, 402 is configured to a control resource set duration of 1 symbol.

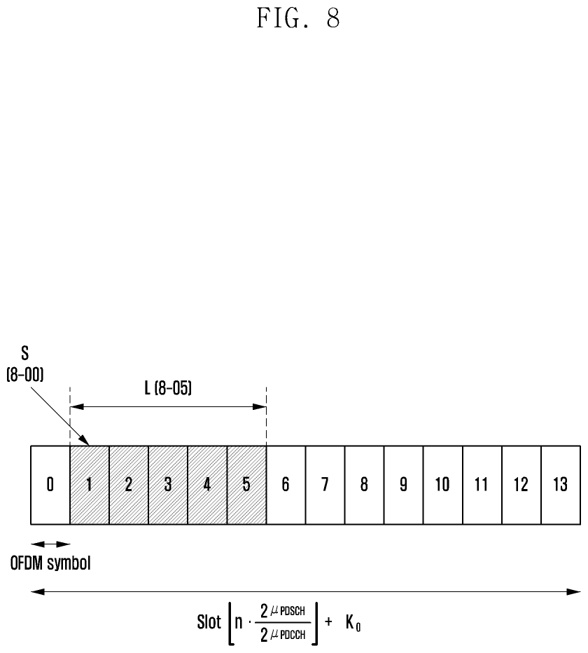

The CORESET in the above-described 5G may be configured by the base station to the UE through higher layer signaling (e.g., system information, master information block (MIB), radio resource control (RRC) signaling). Configuring the CORESET to the UE means providing information such as a CORESET identity, a frequency location of the CORESET, and a symbol length of the CORESET. For example, it may include information of FIG. 8.

TABLE 8

| | |
|---|---|
| ControlResourceSet ::= | SEQUENCE { |

```
        -- Corresponds to L1 parameter ‘CORESET-ID’
        controlResourceSetId
        ControlResourceSetId,
  (control area identity)
```

| | |
|---|---|
| frequencyDomainResources | BIT STRING (SIZE |

(45)),
(frequency axis resource assignment information)

| | |
|---|---|
| duration | INTEGER |

```
(1..maxCoReSetDuration),
  (time axis resource assignment information)
        cce-REG-MappingType
        CHOICE {
  (CCE-to-REG mapping method)
          interleaved
        SEQUENCE {
              reg-BundleSize
        ENUMERATED {n2, n3, n6},
      (REG bundle size)
              precoderGranularity
        ENUMERATED {sameAsREG-bundle, allContiguousRBs},
              interleaverSize
        ENUMERATED {n2, n3, n6}
              (interleaver size)
              shiftIndex
        INTEGER(0..maxNrofPhysicalResourceBlocks-1)
                  OPTIONAL
            (interleaver shift)
    },
```

| | |
|---|---|
| nonInterleaved | NULL |

```
        },
        tci-StatesPDCCH
        SEQUENCE(SIZE (1..maxNrofTCI-StatesPDCCH)) OF TCI-StateId
                OPTIONAL,
  (QCL configuration information)
```

| | |
|---|---|
| tci-PresentInDCI | ENUMERATED |

{enabled}
OPTIONAL, -- Need S
}

In Table 8, tci-StatesPDCCH (simply referred to as a transmission configuration indication (TCI) state) configuration information may include one or a plurality of synchronization signal (SS)/physical broadcast channel (PBCH) block index or channel state information reference signal (CSI-RS) index information in a quasi co located (QCL) relationship with a ˜˜˜ (DMRS) transmitted in the corresponding CORESET.

FIG. 5 is a diagram illustrating an example of a basic unit of time and frequency resources constituting a downlink control channel that may be used in 5G according to an embodiment of the disclosure.

Referring to FIG. 5, a basic unit of time and frequency resources constituting a control channel may be referred to as a resource element group (REG) 503, and the REG 503 may be defined to 1 OFDM symbol 501 in the time axis and 1 physical resource block (PRB) 502 in the frequency axis, that is, 12 subcarriers. The base station may concatenate the REG 503 to constitute a downlink control channel allocation unit.

As illustrated in FIG. 5, in the case that a basic unit to which a downlink control channel is allocated in 5G is a control channel element (CCE) 504, 1 CCE 504 may be composed of a plurality of REGs 503. When the REG 503 illustrated in FIG. 5 is described as an example, the REG 503 may be composed of 12 REs, and when 1 CCE 504 is composed of 6 REGs 503, 1 CCE 504 may be composed of 72 REs. When a downlink control area is configured, the corresponding area may be composed of a plurality of CCEs 504, and a specific downlink control channel may be mapped and transmitted to one or a plurality of CCEs 504 according to an aggregation level (AL) in the control area. The CCEs 504 in the control area are identified by numbers, and in this case, the numbers of the CCEs 504 may be given according to a logical mapping method.

The basic unit of the downlink control channel illustrated in FIG. 5, that is, the REG 503 may include both REs to which DCI is mapped and an area to which a DMRS 505, which is a reference signal for decoding them, is mapped. As illustrated in FIG. 5, three DMRSs 505 may be transmitted within one REG 503. The number of CCEs required to transmit the PDCCH may be 1, 2, 4, 8, or 16 according to an aggregation level (AL), and the numbers of different CCEs may be used for implementing link adaptation of the downlink control channel. For example, in the case that AL=L, one downlink control channel may be transmitted through the L number of CCEs. The UE should detect a signal without knowing information on a downlink control channel, and a search space representing a set of CCEs is defined for blind decoding. The search space is a set of downlink control channel candidates consisting of CCEs in which the UE should attempt to decode on a given aggregation level, and because there are various aggregations levels that make one group with 1, 2, 4, 8, and 16 CCEs, the UE may have a plurality of search spaces. A search space set may be defined as a set of search spaces in all configured aggregation levels.

The search space may be classified into a common search space and a UE-specific search space. In order to receive cell common control information such as dynamic scheduling for system information or paging messages, a certain group of UEs or all UEs may search for the common search space of the PDCCH. For example, PDSCH scheduling allocation information for transmission of an SIB including cell operator information may be received by searching for the common search space of the PDCCH. In the case of a common search space, because a certain group of UEs or all UEs should receive the PDCCH, the common search space may be defined as a set of pre-promised CCEs. Scheduling allocation information on the UE-specific PDSCH or PUSCH may be received by searching for the UE-specific search space of the PDCCH. The UE-specific search space may be defined UE-specifically as a function of various system parameters and the identity of the UE.

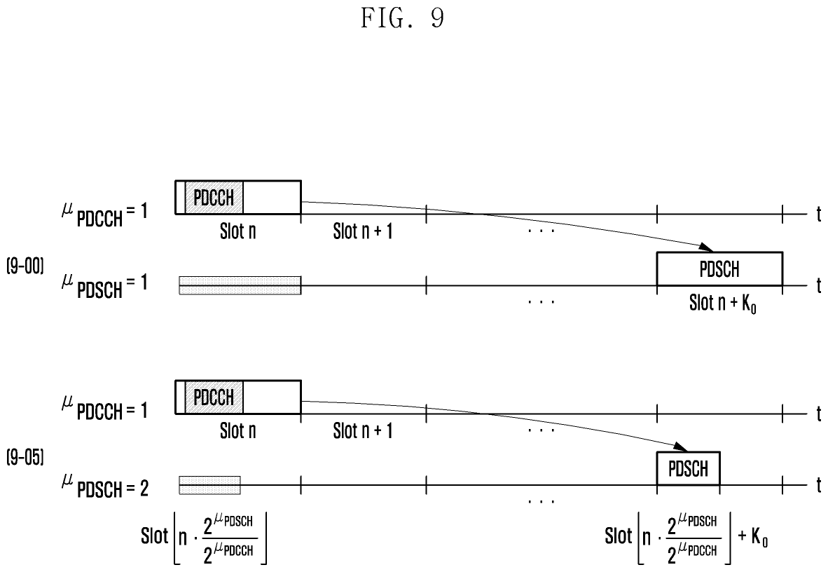

In 5G, a parameter for a search space for a PDCCH may be configured from the base station to the UE through higher layer signaling (e.g., SIB, MIB, RRC signaling). For example, the base station may configure the number of PDCCH candidates at each aggregation level L, a monitoring period for the search space, a monitoring occasion in units of a symbol within a slot for the search space, a search space type (common search space or UE-specific search space), a combination of a DCI format and a radio network temporary identifier (RNTI) to be monitored in a corresponding search space, and a CORESET index to monitor a search space to the UE. For example, the parameter for the search space for the PDCCH may include information of FIG. 9.

TABLE 9

| | |
|---|---|
| SearchSpace ::= | SEQUENCE { |

```
      -- Identity of the search space. SearchSpaceId = 0 identifies the SearchSpace
configured via PBCH (MIB) or ServingCellConfigCommon.
      searchSpaceId
      SearchSpaceId,
  (search space identifier)
      controlResourceSetId
      ControlResourceSetId,
  (control area identifier)
```

| | |
|---|---|
| monitoringSlotPeriodicityAndOffset | CHOICE { |

```
  (monitoring slot level period)
        sl1
      NULL,
        sl2
      INTEGER (0..1),
        sl4
      INTEGER (0..3),
        sl5
      INTEGER (0..4),
        sl8
      INTEGER (0..7),
        sl10
      INTEGER (0..9),
        sl16
      INTEGER (0..15),
        sl20
      INTEGER (0..19)
      }
```

| | |
|---|---|
| | OPTIONAL, |
| duration(monitoring length) | INTEGER (2..2559) |

| | |
|---|---|
| monitoringSymbolsWithinSlot | BIT STRING |

```
(SIZE (14))
        OPTIONAL,
  (monitoring symbol within slot)
```

| | |
|---|---|
| nrofCandidates | SEQUENCE { |

```
  (number of PDCCH candidates for each aggregation level)
        aggregationLevel1
      ENUMERATED {n0, n1, n2, n3, n4, n5, n6, n8},
        aggregationLevel2
      ENUMERATED {n0, n1, n2, n3, n4, n5, n6, n8},
        aggregationLevel4
      ENUMERATED {n0, n1, n2, n3, n4, n5, n6, n8},
        aggregationLevel8
      ENUMERATED {n0, n1, n2, n3, n4, n5, n6, n8},
        aggregationLevel16
      ENUMERATED {n0, n1, n2, n3, n4, n5, n6, n8}
      },
```

| | |
|---|---|
| searchSpaceType | CHOICE { |

```
      (search space type)
        -- Configures this search space as common search space (CSS) and
DCI formats to monitor.
        common
      SEQUENCE {
      (common search space)
    }
        ue-Specific
      SEQUENCE {
      (UE-specific search space)
          -- Indicates whether the UE monitors in this USS for DCI
formats 0-0 and 1-0 or for formats 0-1 and 1-1.
          formats
      ENUMERATED {formats0-0-And-1-0, formats0-1-And-1-1},
          ...
      }
```

According to configuration information, the base station may configure one or a plurality of search space sets to the UE. According to some embodiments, the base station may configure a search space set 1 and a search space set 2 to the UE, configure to monitor a DCI format A scrambled with an X-RNTI in the common search space in the search space set 1, and configure to monitor a DCI format B scrambled with a Y-RNTI in the UE-specific search space in the search space set 2.

According to configuration information, one or a plurality of search space sets may exist in a common search space or a UE-specific search space. For example, a search space set #1 and a search space set #2 may be configured to common search spaces, and a search space set #3 and a search space set #4 may be configured to UE-specific search spaces.

In the common search space, a combination of the following DCI format and RNTI may be monitored. The disclosure is not limited to the following examples.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, the combination of the following DCI format and RNTI may be monitored. The disclosure is not limited to the following examples.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The specified RNTIs may follow the following definitions and uses.
C-RNTI (Cell RNTI): Used for scheduling a UE-specific PDSCH
TC-RNTI (Temporary Cell RNTI): Used for scheduling a UE-specific PDSCH
CS-RNTI (Configured Scheduling RNTI): Used for scheduling a semi-statically configured UE-specific PDSCH
RA-RNTI (Random Access RNTI): Used for scheduling a PDSCH in a random access step
P-RNTI (Paging RNTI): Used for scheduling a PDSCH in which paging is transmitted
SI-RNTI (System Information RNTI): Used for scheduling a PDSCH through which system information is transmitted
INT-RNTI (Interruption RNTI): Used for notifying whether puncturing for a PDSCH
TPC-PUSCH-RNTI (Transmit Power Control for PUCCH RNTI): Used for indicating a power control command for a PUSCH
TPC-PUCCH-RNTI (Transmit Power Control for PUCCH RNTI): Used for indicating a power control command for a PUCCH
TPC-SRS-RNTI (Transmit Power Control for SRS RNTI): Used for indicating a power control command for an SRS

The above-described specified DCI formats may follow the definition such as an example of Table 10.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH |
| | and PUSCH |
| 2_3 | Transmission of a group of TPC commands |
| | for SRS transmissions by one or more UEs |

In 5G, a search space of an aggregation level L in a control area p and a search space set s may be expressed as in Equation 1.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad Equation 1$$

L: aggregation level
n_{CI}: carrier index
N_{CCE,p}: the number of total CCEs existing in a control area p
n_{s,f}^{μ}: slot index
M_{s,max}^{(L)}: the number of PDCCH candidates of the aggregation level L
m_{s,n}_{_{CI}}=0, . . . , M_{s,max}^{(L)}−1: PDCCH candidate index of the aggregation level L
i=0, . . . , L−1
   Y_{p,n}_{_{s,f}}_{^{μ}}=(Aₚ·Y_{p,n}_{_{s,f}}_{^{μ}}₋₁)mod D, Y_{p,-1}=n_{RNTI}≠0, Aₚ=39827 for p mod 3=0, Aₚ=39829 for p mod 3=1, Aₚ=39839 for p mod 3=2, D=65537
n_{RNTI}: UE identifier

The Y_{p,n}_{_{s,f}}_{^{μ}} value may correspond to 0 in the case of a common search space.

In the case of a UE-specific search space, the Y_{p,n}_{_{s,f}}_{^{μ}} value may correspond to a value that changes according to an identity of the UE (C-RNTI or an ID configured to the UE by the base station) and a time index.

In 5G, as a plurality of search space sets may be configured with different parameters (e.g., parameters in Table 9), a set of search space sets monitored by the UE at each time point may be different. For example, in the case that a search space set #1 is configured to an X-slot period and that a search space set #2 is configured to a Y-slot period and that X and Y are different, the UE may monitor both the search space set #1 and the search space set #2 in a specific slot and monitor one of the search space set #1 and the search space set #2 in a specific slot.

### PDCCH: BD/CCE Limit

In the case that a plurality of search space sets are configured to the UE, the following conditions may be considered in a method of determining a search space set in which the UE should monitor.

When the UE receives a configuration of a value of monitoringCapabilityConfig-r16, which is upper layer signaling to r15monitoringcapability, the UE may define a maximum value for the number of PDCCH candidates that may be monitored and the number of CCEs constituting the entire search space (here, the entire search space means the entire CCE set corresponding to a union area of a plurality of search space sets) for each slot, and when a value of monitoringCapabilityConfig-r16 is configured to r16monitoringcapability, the UE defines a maximum value for the number of PDCCH candidates that may be monitored and the number of CCEs constituting the entire search space (here, the entire search space means the entire CCE set corresponding to an union area of a plurality of search space sets) for each span.

### Condition 1: Limit the Maximum Number of PDCCH Candidates

As described above, according to a configuration value of upper layer signaling, M^{μ}, which is the maximum number of PDCCH candidates that may be monitored by the UE may follow Table 11 in the case of being defined based on a slot in a cell configured to subcarrier spacing 15.24 kHz, and follow Table 12 in the case of being defined based on a span.

TABLE 11

| | Maximum number of PDCCH candidates |
|---|---|
| μ | per slot and per serving cell (Mμ) |
| 0 | 44 |
| 1 | 36 |
| 2 | 22 |
| 3 | 20 |

TABLE 12

| | Maximum number Mμ of monitored PDCCH candidates | | |
|---|---|---|---|
| | per span for combination (X, Y) and per serving cell | | |
| μ | (2, 2) | (4, 3) | (7, 3) |
| 0 | 14 | 28 | 44 |
| 1 | 12 | 24 | 36 |

### Condition 2: Limit the Maximum Number of CCEs

As described above, according to a configuration value of upper layer signaling, C^{μ}, which is the maximum number of CCEs constituting the entire search space (here, the entire search space means the entire CCE set corresponding to a union area of a plurality of search space sets) may follow Table 13 in the case of being defined based on a slot in a cell configured to subcarrier spacing 15.24 kHz and follow Table 14 in the case of being defined based on a span.

TABLE 13

| | Maximum number of non-overlapped CCEs per slot |
|---|---|
| μ | and per serving cell (Cμ) |
| 0 | 56 |
| 1 | 56 |
| 2 | 48 |
| 3 | 32 |

TABLE 14

| | Maximum number Cμ of non-overlapped CCEs per | | |
|---|---|---|---|
| | span for combination (X, Y) and per serving cell | | |
| μ | (2, 2) | (4, 3) | (7, 3) |
| 0 | 18 | 36 | 56 |
| 1 | 18 | 36 | 56 |

For convenience of description, a situation in which both the above conditions 1 and 2 are satisfied at a specific time point will be defined as a “condition A.” Therefore, not satisfying a condition A may mean not satisfying at least one of the above conditions 1 or 2.

### PDCCH: Overbooking

According to a configuration of search space sets of the base station, the case that a condition A is not satisfied at a specific time point may occur. In the case that the condition A is not satisfied at a specific time point, the UE may select and monitor only some of search space sets configured to satisfy the condition A at the corresponding time point, and the base station may transmit a PDCCH to the selected search space set.

A method of selecting some search spaces from the entire configured search space set may follow the following method.

In the case that a condition A for a PDCCH is not satisfied at a specific time point (slot), the UE (or the base station) may preferentially select a search space set whose search space type is configured to a common search space over a search space set whose search space type is configured to a UE-specific search space among search space sets existing at the corresponding time point.

In the case that all search space sets configured to common search spaces are selected (i.e., in the case that a condition A is satisfied even after selecting all search spaces configured to common search spaces), the UE (or the base station) may select search space sets configured to a UE-specific search space. In this case, in the case that there are multiple search space sets configured to UE-specific search spaces, a search space set with a lower search space set index may have a higher priority. Considering a priority, UE-specific search space sets may be selected within the range in which a condition A is satisfied.

### Related to Rate Matching/Puncturing

Hereinafter, a rate matching operation and a puncturing operation will be described in detail.

In the case that a time and frequency resource A to transmit a random symbol sequence A overlaps with a random time and frequency resource B, a rate matching or puncturing operation may be considered by a transmitting and receiving operation of a channel A considering an area resource C in which the resource A and the resource B overlap. A specific operation thereof may follow the following description.

### Rate Matching Operation

The base station may map and transmit a channel A only to the remaining resource domains excluding a resource C corresponding to an area overlapped with a resource B among all resources A to transmit a symbol sequence A to the UE. For example, in the case that the symbol sequence A is composed of {symbol #1, symbol #2, symbol #3, symbol 4} and that the resource A is {resource #1, resource #2, resource #3, resource #4} and that the resource B is {resource #3, resource #5}, the base station may sequentially map and transmit a symbol sequence A to the remaining resources {resource #1, resource #2, resource #4} excluding {resource #3} corresponding to the resource C among the resource A. As a result, the base station may map and transmit the symbol sequence {symbol #1, symbol #2, and symbol #3} to {resource #1, resource #2, and resource #4}, respectively.

The UE may determine a resource A and a resource B from scheduling information on the symbol sequence A from the base station, thereby determining a resource C, which is an area in which the resource A and the resource B overlap. The UE may assume that the symbol sequence A is mapped and transmitted in the remaining areas excluding the resource C among the entire resource A and receive the symbol sequence A. For example, in the case that the symbol sequence A is composed of {symbol #1, symbol #2, symbol #3, symbol 4} and that the resource A is {resource #1, resource #2, resource #3, resource #4} and that the resource B is {resource #3, resource #5}, the UE may assume and receive that the symbol sequence A is sequentially mapped to the remaining resources {resource #1, resource #2, resource #4} excluding {resource #3} corresponding to the resource C among the resource A. As a result, the UE may assume that the symbol sequence {symbol #1, symbol #2, and symbol #3} is mapped and transmitted to {resource #1, resource #2, and resource #4}, respectively, and perform a series of subsequent reception operations.

### Puncturing Operation

In the case that a corresponding resource C exists in an area overlapped with a resource B among the entire resource A to transmit a symbol sequence A to the UE, the base station may a symbol sequence A to the entire resource A, but may not perform transmission in a resource area corresponding to the resource C, and may perform transmission only in the remaining resource areas excluding the resource C among the resource A. For example, in the case that the symbol sequence A is composed of {symbol #1, symbol #2, symbol #3, symbol 4} and that the resource A is {resource #1, resource #2, resource #3, resource #4} and that the resource B is {resource #3, resource #5}, the base station may map the symbol sequence A {symbol #1, symbol #2, symbol #3, symbol #4} to the resource A {resource #1, resource #2, resource #3, resource #4}, respectively, transmit only the symbol sequences {symbol #1, symbol #2, symbol #4} corresponding to the remaining resources {resource #1, resource #2, resource #4} excluding {resource #3} corresponding to the resource C among the resource A, but may not transmit {symbol #3} mapped to {resource #3} corresponding to the resource C. As a result, the base station may map and transmit the symbol sequence {symbol #1, symbol #2, and symbol #4} to {resource #1, resource #2, and resource #4}, respectively.

The UE may determine a resource A and a resource B from scheduling information on the symbol sequence A from the base station, thereby determining a resource C, which is an area in which the resource A and the resource B overlap. The UE may receive the symbol sequence A assuming that the symbol sequence A is mapped to the entire resource A and transmitted only in the remaining areas excluding the resource C among the resource area A. For example, in the case that the symbol sequence A is composed of {symbol #1, symbol #2, symbol #3, symbol 4} and that the resource A is {resource #1, resource #2, resource #3, resource #4} and that the resource B is {resource #3, resource #5}, the UE may map the symbol sequence A {symbol #1, symbol #2, symbol #3, symbol #4} to the resource A {resource #1, resource #2, resource #3, resource #4}, respectively, but assume that {symbol #3} mapped to {resource #3} corresponding to the resource C is not transmitted, and assume and receive that the symbol sequence {symbol #1, symbol #2, symbol #4} corresponding to the remaining resources {resource #1 and resource #2, resource #4} excluding {resource #3} corresponding to the resource C among the resource A has been mapped and transmitted. As a result, the UE may assume that the symbol sequence {symbol #1, symbol #2, and symbol #3} is mapped and transmitted to {resource #1, resource #2, and resource #4}, respectively, and perform a series of subsequent reception operations.

Hereinafter, a method of configuring a rate matching resource for the purpose of rate matching in the 5G communication system will be described. Rate matching means that a magnitude of a signal is adjusted in consideration of an amount of resources that may transmit the signal. For example, rate matching of a data channel may mean that the data channel is not mapped and transmitted for a specific time and frequency resource area, thereby adjusting the magnitude of data.

FIG. 6 is a diagram illustrating a method in which a base station and a UE transmit and receive data in consideration of a physical downlink shared channel and rate matching resource according to an embodiment of the disclosure.

Referring to FIG. 6, a physical downlink shared channel (PDSCH) 601 and a rate matching resource 602 are illustrated. The base station may configure one or multiple rate matching resources 602 to the UE through higher layer signaling (e.g., RRC signaling). Rate matching resource 602 configuration information may include time axis resource assignment information 603, frequency axis resource assignment information 604, and period information 605. Hereinafter, a bitmap corresponding to the frequency axis resource assignment information 604 is referred to as a “first bitmap,” a bitmap corresponding to the time axis resource assignment information 603 is referred to as a “second bitmap,” and a bitmap corresponding to the period information 605 is referred to as a “third bitmap”. In the case that all or part of the time and frequency resources of the scheduled data channel (e.g., PDSCH 601) overlap with the configured rate matching resource 602, the base station may rate match and transmit the data channel (e.g., PDSCH 601) in the rate matching resource 602 portion, and the UE may perform reception and decoding after assuming that the data channel (e.g., PDSCH 601) was rate matched in the rate matching resource 602 portion.

Through an additional configuration, the base station may dynamically notify the UE through DCI whether to rate match the data channel in the configured rate matching resource portion (corresponding to the “rate matching indicator” in the above-mentioned DCI format). Specifically, the base station may select some of the configured rate matching resources and group them into a rate matching resource group, and instruct to the UE whether to rate match a data channel for each rate matching resource group with DCI using a bitmap method. For example, in the case that four rate matching resources, RMR #1, RMR #2, RMR #3, and RMR #4 are configured, the base station may configure RMG #1={RMR #1, RMR #2}, RMG #2={RMR #3, RMR #4} as a rate matching group, and instruct to the UE whether to perform rate matching in each of RMG #1 and RMG #2 with a bitmap using 2 bits in the DCI field. For example, in the case that rate matching should be performed, “1” may be indicated, and in the case that rate matching should not be performed, “0” may be indicated.

In 5G, the granularity of “RB symbol level” and “RE level” is supported with a method of configuring the above-described rate matching resource to the UE. More specifically, the following configuration method may be followed.

### RB Symbol Level

The UE may be configured with maximum four RateMatchPatterns for each bandwidth part through upper layer signaling, and one RateMatchPattern may include the following contents.
It is a reserved resource within the bandwidth part and may include a resource in which time and frequency resource areas of the reserved resource are configured by combining an RB level bitmap and a symbol level bitmap on the frequency axis. The reserved resource may be spanned over one or two slots. A time domain pattern (periodicity AndPattern) in which time and frequency domains composed of each RB level and symbol level bitmap pair are repeated may be additionally configured.
It may include a time and frequency domain resource area configured with a control resource set within the bandwidth part and a resource area corresponding to a time domain pattern configured with a search space configuration in which the resource area is repeated.

### RE Level

The UE may be configured with the following contents through upper layer signaling.
It is configuration information (lte-CRS-ToMatchAround) on an RE corresponding to LTE cell specific reference signal (CRS) (Cell-specific Reference Signal or Common Reference Signal) pattern and may include the number of ports (nrofCRS-Ports) and LTE-CRS-vshift(s) value (v-shift) of LTE CRS, LTE carrier center subcarrier location information (carrierFreqDL), LTE carrier bandwidth size (carrierBandwidthDL) information, and subframe configuration information (mbsfn-SubframConfigList) corresponding to a multicast-broadcast single-frequency network (MBSFN) from a reference frequency point (e.g., reference point A). The UE may determine a location of the CRS within the NR slot corresponding to the LTE subframe based on the above-described information.
It may include configuration information on a resource set corresponding to one or multiple Zero Power (ZP) CSI-RS within the bandwidth part.

### Related to LTE CRS Rate Match

Hereinafter, a rate match process for the above-described LTE CRS will be described in detail. For coexistence (LTE-NR Coexistence) of long term evolution (LTE) and new RAT (NR), the NR provides a function of configuring a pattern of a cell specific reference signal (CRS) of LTE to the NR UE. More specifically, the CRS pattern may be provided by RRC signaling including at least one parameter in the ServingCellConfig Information Element (IE) or ServingCellConfigCommon IE. The above parameters may include, for example, lte-CRS-ToMatchAround, Ite-CRS-PatternList1-r16, Ite-CRS-PatternList2-r16, and crs-RateMatch-PerCORESETPoolIndex-r16.

Rel-15 NR provides a function in which one CRS pattern may be configured per serving cell through the lte-CRS-ToMatchAround parameter. In Rel-16 NR, the above function has been expanded to enable a configuration of a plurality of CRS patterns per serving cell. More specifically, in a single-transmission and reception point (TRP) configuration UE, one CRS pattern may be configured per LTE carrier, and in a multi-TRP configuration UE, two CRS patterns may be configured per LTE carrier. For example, in a single-TRP configuration UE, maximum three CRS patterns may be configured per serving cell through the lte-CRS-PatternList1-r16 parameter. As another example, in a multi-TRP configuration UE, a CRS may be configured for each TRP. That is, a CRS pattern for TRP1 may be configured through the lte-CRS-PatternList1-r16 parameter, and a CRS pattern for TRP2 may be configured through the lte-CRS-PatternList2-r16 parameter. In the case that two TRPs are configured, as described above, whether all CRS patterns of TRP1 and TRP2 are applied or only the CRS pattern for one TRP is applied to a specific physical downlink shared channel (PDSCH) is determined through a crs-RateMatch-PerCORESETPoolIndex-r16 parameter, and when the crs-RateMatch-PerCORESETPoolIndex-r16 parameter is configured to enabled, only the CRS pattern of one TRP is applied, and in other cases, all CRS patterns of both TRPs are applied.

Table 15 illustrates a ServingCellConfig IE including the CRS pattern, and Table 16 illustrates a RateMatchPatternLTE-CRS IE including at least one parameter for the CRS pattern.

TABLE 15

| | |
|---|---|
| ServingCellConfig ::= | SEQUENCE { |

| | |
|---|---|
| tdd-UL-DL-ConfigurationDedicated | TDD-UL-DL-ConfigDedicated |

OPTIONAL, -- Cond TDD

| | |
|---|---|
| initialDownlinkBWP | BWP-DownlinkDedicated |

OPTIONAL, -- Need M

| | |
|---|---|
| downlinkBWP-ToReleaseList | SEQUENCE (SIZE (1..maxNrofBWPs)) OF |

| | |
|---|---|
| BWP-Id | OPTIONAL, -- Need N |

| | |
|---|---|
| downlinkBWP-ToAddModList | SEQUENCE (SIZE (1..maxNrofBWPs)) |

| | |
|---|---|
| OF BWP-Downlink | OPTIONAL, -- Need N |
| firstActiveDownlinkBWP-Id | BWP-Id |

OPTIONAL, -- Cond SyncAndCellAdd

| | |
|---|---|
| bwp-InactivityTimer | ENUMERATED {ms2, ms3, ms4, ms5, ms6, |

ms8, ms10, ms20, ms30,

ms40,ms50, ms60, ms80,ms100, ms200,ms300,

ms500,

ms750, ms1280, ms1920, ms2560, spare10, spare9,

spare8,

spare7, spare6, spare5, spare4, spare3, spare2,

spare1 } OPTIONAL, -- Need R

| | |
|---|---|
| defaultDownlinkBWP-Id | BWP-Id |

OPTIONAL, -- Need S

| | |
|---|---|
| uplinkConfig | UplinkConfig |

OPTIONAL, -- Need M

| | |
|---|---|
| supplementaryUplink | UplinkConfig |

OPTIONAL, -- Need M

| | |
|---|---|
| pdcch-ServingCellConfig | SetupRelease { PDCCH-ServingCellConfig } |

OPTIONAL, -- Need M

| | |
|---|---|
| pdsch-ServingCellConfig | SetupRelease { PDSCH-ServingCellConfig } |

OPTIONAL, -- Need M

| | |
|---|---|
| csi-MeasConfig | SetupRelease { CSI-MeasConfig } |

OPTIONAL, -- Need M

| | |
|---|---|
| sCellDeactivationTimer | ENUMERATED {ms20, ms40, ms80, ms160, |

ms200, ms240,

```
  ms320, ms400, ms480, ms520, ms640, ms720,
  ms840, ms1280, spare2,spare1} OPTIONAL, -
```

- Cond ServingCellWithoutPUCCH

| | |
|---|---|
| crossCarrierSchedulingConfig | CrossCarrierSchedulingConfig |

OPTIONAL, -- Need M

| | |
|---|---|
| tag-Id | TAG-Id, |
| dummy | ENUMERATED {enabled} |

OPTIONAL, -- Need R

| | |
|---|---|
| pathlossReferenceLinking | ENUMERATED {spCell, sCell} |

OPTIONAL, -- Cond SCellOnly

| | |
|---|---|
| servingCellMO | MeasObjectId |

```
OPTIONAL, -- Cond MeasObject
  ...,
  [[
```

| | |
|---|---|
| lte-CRS-ToMatchAround | SetupRelease { RateMatchPatternLTE-CRS } |

OPTIONAL, -- Need M

| | |
|---|---|
| rateMatchPatternToAddModList | SEQUENCE (SIZE |

(1..maxNrofRateMatchPatterns)) OF RateMatchPattern OPTIONAL, -- Need
N

| | |
|---|---|
| rateMatchPatternToReleaseList | SEQUENCE (SIZE |

(1..maxNrofRateMatchPatterns)) OF RateMatchPatternId OPTIONAL, -- Need
N

| | |
|---|---|
| downlinkChannelBW-PerSCS-List | SEQUENCE (SIZE (1..maxSCSs)) OF |

| | |
|---|---|
| SCS-SpecificCarrier | OPTIONAL -- Need S |

```
  ]],
  [[
```

| | |
|---|---|
| supplementaryUplinkRelease | ENUMERATED {true} |

OPTIONAL, -- Need N
tdd-UL-DL-ConfigurationDedicated-IAB-MT-r16 TDD-UL-DL-

| | |
|---|---|
| ConfigDedicated-IAB-MT-r16 | OPTIONAL, -- Cond TDD_IAB |

| | |
|---|---|
| dormantBWP-Config-r16 | SetupRelease { DormantBWP-Config-r16 } |

OPTIONAL, -- Need M

| | |
|---|---|
| ca-SlotOffset-r16 | CHOICE { |
| refSCS15kHz | INTEGER (−2..2), |
| refSCS30KHz | INTEGER (−5..5), |
| refSCS60KHz | INTEGER (−10..10), |
| refSCS120KHz | INTEGER (−20..20) |

| | |
|---|---|
| } | OPTIONAL, |

-- Cond AsyncCA

| | |
|---|---|
| channelAccessConfig-r16 | SetupRelease { ChannelAccessConfig-r16 } |

OPTIONAL, -- Need M

| | |
|---|---|
| intraCellGuardBandsDL-List-r16 | SEQUENCE (SIZE (1..maxSCSs)) OF |
| IntraCellGuardBandsPerSCS-r16 | OPTIONAL, -- Need S |
| intraCellGuardBandsUL-List-r16 | SEQUENCE (SIZE (1..maxSCSs)) OF |
| IntraCellGuardBandsPerSCS-r16 | OPTIONAL, -- Need S |

| | |
|---|---|
| csi-RS-ValidationWith-DCI-r16 | ENUMERATED {enabled} |

OPTIONAL, -- Need R

| | |
|---|---|
| lte-CRS-PatternList1-r16 | SetupRelease { LTE-CRS-PatternList-r16 } |

OPTIONAL, -- Need M

| | |
|---|---|
| lte-CRS-PatternList2-r16 | SetupRelease { LTE-CRS-PatternList-r16 } |

OPTIONAL, -- Need M
crs-RateMatch-PerCORESETPoolIndex-r16 ENUMERATED {enabled}
OPTIONAL, -- Need R

| | |
|---|---|
| enableTwoDefaultTCI-States-r16 | ENUMERATED {enabled} |

OPTIONAL, -- Need R
enableDefaultTCI-StatePerCoresetPoolIndex-r16 ENUMERATED {enabled}
OPTIONAL, -- Need R

| | |
|---|---|
| enableBeamSwitchTiming-r16 | ENUMERATED {true} |

OPTIONAL, -- Need R

| | |
|---|---|
| cbg-TxDiffTBsProcessingType1-r16 | ENUMERATED {enabled} |

OPTIONAL, -- Need R

| | |
|---|---|
| cbg-TxDiffTBsProcessingType2-r16 | ENUMERATED {enabled} |

OPTIONAL -- Need R
]]
}

TABLE 16
- RateMatchPatternLTE-CRS
The IE RateMatchPatternLTE-CRS is used to configure a pattern to rate match
around LTE CRS. See TS 38.214 [19], clause 5.1.4.2.
RateMatchPatternLTE-CRS information element
-- ASNISTART
-- TAG-RATEMATCHPATTERNLTE-CRS-START

| | |
|---|---|
| RateMatchPatternLTE-CRS ::= | SEQUENCE { |
| carrierFreqDL | INTEGER (0..16383), |
| carrierBandwidthDL | ENUMERATED {n6, n15, n25, n50, n75, n100, |
| spare2, spare1 }, | |
| mbsfn-SubframeConfigList | EUTRA-MBSFN-SubframeConfigList |
| OPTIONAL, -- Need M | |
| nrofCRS-Ports | ENUMERATED {n1, n2, n4}, |
| v-Shift | ENUMERATED {n0, n1, n2, n3, n4, n5} |
| } | |
| LTE-CRS-PatternList-r16 ::= | SEQUENCE (SIZE (1..maxLTE-CRS-Patterns- |

r16)) OF RateMatchPatternLTE-CRS
-- TAG-RATEMATCHPATTERNLTE-CRS-STOP
-- ASN1STOP
RateMatchPatternLTE-CRS field descriptions
carrierBandwidthDL
BW of the LTE carrier in number of PRBs (see TS 38.214 [19], clause 5.1.4.2).
carrierFreqDL
Center of the LTE carrier (see TS 38.214 [19], clause 5.1.4.2).
mbsfn-SubframeConfigList
LTE MBSFN subframe configuration (see TS 38.214 [19], clause 5.1.4.2).
nrofCRS-Ports
Number of LTE CRS antenna port to rate-match around (see TS 38.214 [19],
clause 5.1.4.2).
v-Shift
Shifting value v-shift in LTE to rate match around LTE CRS (see TS 38.214 [19],
clause 5.1.4.2).

### PDSCH: Related to Frequency Resource Assignment

FIG. 7 is a diagram illustrating an example of frequency axis resource assignment of a physical downlink shared channel (PDSCH) in a wireless communication system according to an embodiment of the disclosure.

FIG. 7 is a diagram illustrating three frequency axis resource assignment methods of type 0, type 1, and dynamic switch that may be configured through an upper layer in an NR wireless communication system.

Referring to FIG. 7, in the case that the UE is configured to use only a resource type 0 7-00 through higher layer signaling, some downlink control information (DCI) that allocates a PDSCH to the corresponding UE includes a bitmap composed of the NRBG number of bits. Conditions for this will be described later. In this case, the NRBG means the number of resource block groups (RBGs) determined as illustrated in Table 17 according to the BWP size assigned by the BWP indicator and the upper layer parameter rbg-Size, and data is transmitted to the RBG indicated as 1 by the bitmap.

TABLE 17

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

In the case that the UE is configured to use only a resource type 1 7-05 through higher layer signaling, some DCI that allocates a PDSCH to the UE include frequency axis resource assignment information composed of the ┌log₂(N_{RB}^{DL,BWP}(N_{RB}^{DL,BWP}+1)/2┐ number of bits. Conditions for this will be described later. Thereby, the base station may configure a starting VRB 7-20 and a length 7-25 of frequency axis resources continuously allocated therefrom.

In the case that the UE is configured to use both a resource type 0 and a resource type 1 7-10 through upper layer signaling, some DCI that allocates a PDSCH to the UE include frequency axis resource assignment information composed of bits of a payload 7-15 for configuring a resource type 0 and a larger value 7-35 of payloads (e.g., starting VRB 7-20 and length 7-25) for configuring a resource type 1. Conditions for this will be described later. In this case, one bit 7-30 may be added to a most significant bit (MSB) of frequency axis resource assignment information in the DCI, and in the case that the bit has a value of ‘0’, it may be indicated that a resource type 0 is used, and in the case that the bit has a value of ‘1’, it may be indicated that a resource type 1 is used.

### PDSCH/PUSCH: Related to Time Resource Assignment

Hereinafter, a time domain resource assignment method for a data channel in a next generation mobile communication system (5G or NR system) is described.

The base station may configure a table of time domain resource assignment information on a physical downlink shared channel (PDSCH) and a physical uplink shared channel (PUSCH) to the UE through higher layer signaling (e.g., RRC signaling). For the PDSCH, a table consisting of the maximum maxNrofDL-Allocations=16 number of entries may be configured, and for the PUSCH, a table consisting of the maximum maxNrofUL-Allocations=16 number of entries may be configured. In an embodiment, time domain resource assignment information may include PDCCH-to-PDSCH slot timing (corresponding to a time interval in units of a slot between a time point that receives the PDCCH and a time point that transmits the PDSCH scheduled by the received PDCCH, denoted as K0), PDCCH-to-PUSCH slot timing (corresponds to a time interval in units of a slot between a time point that receives the PDCCH and a time point that transmits the PUSCH scheduled by the received PDCCH, denoted as K2), information on a location and length of a start symbol scheduled by the PDSCH or the PUSCH within the slot, a mapping type of the PDSCH or the PUSCH, and the like. For example, information such as Table 18 or Table 19 may be transmitted from the base station to the UE.

TABLE 18

PDSCH-TimeDomainResourceAssignmentList information element
PDSCH-Time DomainResourceAssignmentlist PDSCH-Time
DomainResourceAllocation
SEQUENCE (SIZE (1..maxNrofDL-Allocations)) OF
PDSCH-Time DomainResourceAssignment :: SEQUENCE {
k0 INTEGER (0..32)
OPTIONAL, - Need S
(PDCCH-to-PDSCH timing, slot unit)
mappingType ENUMERATED {typeA, typeB},
(PDSCH mapping type)
startSymbolAndLength INTEGER (0..127)
(start symbol and length of PDSCH)
}

TABLE 19
PUSCH-TimeDomainResourceAssignment information element
PUSCH-Time DomainResourceAssignmentList ::= SEQUENCE (SIZE
(1..maxNrofUL-Allocations)) OF
PUSCH-Time DomainResourceAssignment
PUSCH-Time DomainResourceAssignment ::= SEQUENCE {
k2 INTEGER (0..32) OPTIONAL, - - Need S
(PDCCH-to-PUSCH timing, slot unit)
mappingType ENUMERATED {typeA, typeB},
(PUSCH mapping type)
startSymbolAndLength INTEGER (0..127)
(start symbol and length of PUSCH)
}

The base station may notify the UE of one of entries in a table for the above-described time domain resource allocation information through L1 signaling (e.g., DCI) (e.g., may be indicated by a ‘time domain resource allocation’ field in the DCI). The UE may acquire time domain resource allocation information on a PDSCH or PUSCH based on the DCI received from the base station.

FIG. 8 is a diagram illustrating an example of time axis resource assignment of a PDSCH in a wireless communication system according to an embodiment of the disclosure.

Referring to FIG. 8, the base station may indicate a time axis location of a PDSCH resource according to subcarrier spacing (SCS) μ_{PDSCH} and μ_{PDCCH} and scheduling offset K0 value of a data channel and control channel configured using an upper layer, and an OFDM symbol start location 8-00 and length 8-05 within one slot dynamically indicated through DCI.

FIG. 9 is a diagram illustrating an example of time axis resource assignment according to subcarrier spacing of a data channel and a control channel in a wireless communication system according to an embodiment of the disclosure.

Referring to FIG. 9, in the case that subcarrier spacings of the data channel and the control channel are the same (9-00, μ_{PDSCH}=μ_{PDCCH}), slot numbers for data and control are the same; thus, the base station and the UE may generate scheduling offset according to predetermined slot offset K0. However, in the case that subcarrier spacings of the data channel and the control channel are different (9-05, UPDSCH: APDCCH), slot numbers for data and control are different; thus, the base station and the UE may generate scheduling offset according to the predetermined slot offset K0 based on subcarrier spacing of the PDCCH.

### PUSCH: Related to Transmission Method

Hereinafter, a scheduling method of PUSCH transmission will be described. PUSCH transmission may be dynamically scheduled by the UL grant in DCI or operated by a configured grant Type 1 or Type 2. A dynamic scheduling instruction for PUSCH transmission is possible by a DCI format 0_0 or 0_1.

Configured grant Type 1 PUSCH transmission may be semi-statically configured through reception of configuredGrantConfig including rrc-ConfiguredUplinkGrant in Table 20 through higher signaling without reception of the UL grant in DCI. Configured grant type 2 PUSCH transmission may be scheduled semi-persistently by a UL grant in DCI after receiving configuredGrantConfig not including rrc-ConfiguredUplinkGrant in Table 20 through higher signaling. In the case that PUSCH transmission operates by a configured grant, parameters applied to PUSCH transmission are applied through configuredGrantConfig, which is higher signaling of Table 20 except for dataScramblingIdentityPUSCH, txConfig, codebookSubset, maxRank, and scaling of UCI-OnPUSCH provided by a push-Config of Table 21, which is higher signaling. When the UE is provided with a transformPrecoder in a configuredGrantConfig, which is higher signaling of Table 20, the UE applies tp-pi2BPSK in a push-Config of Table 21 to PUSCH transmission operating by the configured grant.

TABLE 20

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |

| | |
|---|---|
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |

| | |
|---|---|
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, |

sym5x14, sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14,

sym2560x14, sym5120x14,

sym6, sym1x12, sym2x12, sym4x12, sym5x12,

sym8x12, sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |

| | |
|---|---|
| timeDomainAssignment | INTEGER (0..15), |
| frequencyDomainAssignment | BIT STRING (SIZE(18)), |

| | |
|---|---|
| antennaPort | INTEGER (0..31), |

| | |
|---|---|
| dmrs-SeqInitialization | INTEGER (0..1) |

OPTIONAL, -- Need R

| | |
|---|---|
| precodingAndNumberOfLayers | INTEGER (0..63), |

| | |
|---|---|
| srs-ResourceIndicator | INTEGER (0..15) |

OPTIONAL, -- Need R

| | |
|---|---|
| mcsAndTBS | INTEGER (0..31), |

| | |
|---|---|
| frequencyHoppingOffset | INTEGER (1.. |
| maxNrofPhysicalResourceBlocks-1) | OPTIONAL, -- Need R |
| pathlossReferenceIndex | INTEGER (0..maxNrofPUSCH- |

PathlossReferenceRSs-1),
...

| | |
|---|---|
| } | OPTIONAL, |

-- Need R
...
}

Hereinafter, a PUSCH transmission method will be described. A DMRS antenna port for PUSCH transmission is the same as an antenna port for SRS transmission. PUSCH transmission may follow a codebook-based transmission method and a non-codebook-based transmission method, respectively, according to whether a value of txConfig in a push-Config of Table 21, which is higher signaling is ‘codebook’ or ‘nonCodebook’.

As described above, PUSCH transmission may be dynamically scheduled through a DCI format 0_0 or 0_1, and be semi-statically configured by configured grant. When the UE is instructed to schedule PUSCH transmission through a DCI format 0_0, the UE performs a beam configuration for PUSCH transmission using a pucch-spatialRelationInfoID corresponding to an UE-specific PUCCH resource corresponding to the minimum ID within the activated uplink BWP in the serving cell, and in this case, PUSCH transmission is performed based on a single antenna port. The UE does not expect scheduling for PUSCH transmission through a DCI format 0_0 in BWP in which a PUCCH resource including pucch-spatialRelationInfo is not configured. When the UE is not configured with txConfig in push-Config of Table 21, the UE does not expect to be scheduled in a DCI format 0_1.

TABLE 21

| | |
|---|---|
| PUSCH-Config ::= | SEQUENCE { |

| | |
|---|---|
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS- |

| | |
|---|---|
| UplinkConfig } | OPTIONAL, -- Need M |

| | |
|---|---|
| dmrs-UplinkForPUSCH-MappingTypeB | SetupRelease { DMRS- |

| | |
|---|---|
| UplinkConfig } | OPTIONAL, -- Need M |
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER |

(1.. maxNrofPhysicalResourceBlocks-1)

OPTIONAL,

-- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |

| | |
|---|---|
| TimeDomainResourceAllocationList } | OPTIONAL, -- Need M |

| | |
|---|---|
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, |
| qam64LowSE} | OPTIONAL, -- Need S |

| | |
|---|---|
| transformPrecoder | ENUMERATED {enabled, disabled} |

OPTIONAL, -- Need S

| | |
|---|---|
| codebookSubset | ENUMERATED |

{fullyAndPartialAndNonCoherent, partialAndNonCoherent,nonCoherent}

OPTIONAL, --

Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Hereinafter, codebook-based PUSCH transmission will be described. Codebook-based PUSCH transmission may be dynamically scheduled through a DCI format 0_0 or 0_1, and operate quasi-statically by a configured grant. When the codebook-based PUSCH is dynamically scheduled by a DCI format 0_1 or quasi-statically configured by a configured grant, the UE determines a precoder for PUSCH transmission based on an SRS resource indicator (SRI), transmission precoding matrix indicator (TPMI), and transmission rank (the number of PUSCH transmission layers).

In this case, the SRI may be given through a field SRS resource indicator in DCI or may be configured through a srs-ResourceIndicator, which is higher signaling. When transmitting a codebook-based PUSCH, the UE may be configured with at least one SRS resource, and be configured with maximum two SRS resources. In the case that the UE receives the SRI through DCI, the SRS resource indicated by the corresponding SRI means an SRS resource corresponding to the SRI among SRS resources transmitted earlier than the PDCCH including the corresponding SRI. Further, TPMI and transmission rank may be given through a field precoding information and number of layers in DCI or may be configured through precodingAndNumberOfLayers, which is higher signaling. The TPMI is used for indicating a precoder applied to PUSCH transmission. When the UE is configured with one SRS resource, the TPMI is used for indicating a precoder to be applied in the configured one SRS resource. When the UE is configured with a plurality of SRS resources, the TPMI is used for indicating a precoder to be applied in the SRS resource indicated through the SRI.

A precoder to be used for PUSCH transmission is selected from an uplink codebook having the same number of antenna ports as a value of nrofSRS-Ports in SRS-Config, which is higher signaling. In codebook-based PUSCH transmission, the UE determines a codebook subset based on TPMI and codebookSubset in push-Config, which is higher signaling. The codebookSubset in push-Config, which is higher signaling may be configured to one of ‘fullyAndPartialAndNonCoherent’, ‘partialAndNonCoherent’, or ‘nonCoherent’ based on the UE capability reported by the UE to the base station. When the UE reported ‘partialAndNonCoherent’ with the UE capability, the UE does not expect that a value of codebookSubset, which is higher signaling is configured to ‘fullyAndPartialAndNonCoherent’. Further, when the UE reported ‘nonCoherent’ with the UE capability, the UE does not expect that a value of a codebookSubset, which is higher signaling is configured to ‘fullyAndPartialAndNonCoherent’ or ‘partialAndNonCoherent’. In the case that nrofSRS-Ports in an SRS-ResourceSet, which is higher signaling indicates two SRS antenna ports, the UE does not expect that a value of a codebookSubset, which is higher signaling is configured to ‘partialAndNonCoherent’.

The UE may be configured with one SRS resource set in which a value of usage in the SRS-ResourceSet, which is higher signaling is configured to ‘codebook’, and one SRS resource in the corresponding SRS resource set may be indicated through the SRI. When several SRS resources are configured in an SRS resource set in which a usage value in SRS-ResourceSet, which is higher signaling is configured to ‘codebook’, the UE expects that a value of nrofSRS-Ports in the SRS-Resource, which is higher signaling is configured to the same value for all SRS resources.

The UE transmits one or a plurality of SRS resources included in an SRS resource set in which a value of usage is configured to ‘codebook’ to the base station according to higher signaling, and the base station selects one of SRS resources transmitted by the UE to instruct the UE to perform PUSCH transmission using transmission beam information of the SRS resource. In this case, in codebook-based PUSCH transmission, the SRI is used as information for selecting an index of one SRS resource and is included in DCI. Additionally, the base station includes information indicating the TPMI and rank to be used by the UE for PUSCH transmission in the DCI. The UE applies a rank indicated based on a transmission beam of the corresponding SRS resource and a precoder indicated by the TPMI to perform PUSCH transmission using the SRS resource indicated by the SRI.

Hereinafter, non-codebook based PUSCH transmission will be described. Non-codebook based PUSCH transmission may be dynamically scheduled through a DCI format 0_0 or 0_1, and operate quasi-statically by a configured grant. In the case that at least one SRS resource is configured in an SRS resource set in which a value of usage in the SRS-ResourceSet, which is higher signaling is configured to ‘nonCodebook’, the UE may receive scheduling of non-codebook based PUSCH transmission through a DCI format 0_1.

For an SRS resource set in which a value of usage in the SRS-ResourceSet, which is higher signaling is configured to ‘nonCodebook’, the UE may be configured with one connected non-zero power CSI-RS (NZP CSI-RS) resource. The UE may calculate a precoder for SRS transmission through measurement of an NZP CSI-RS resource connected to the SRS resource set. When the difference between a last reception symbol of an aperiodic NZP CSI-RS resource connected to the SRS resource set and a first symbol of aperiodic SRS transmission in the UE is smaller than 42 symbols, the UE does not expect that information on the precoder for SRS transmission is updated.

When a value of resourceType in SRS-ResourceSet, which is higher signaling is configured to ‘aperiodic’, the connected NZP CSI-RS is indicated by an SRS request, which is a field in a DCI format 0_1 or 1_1. In this case, when the connected NZP CSI-RS resource is an aperiodic NZP CSI-RS resource, it indicates that the connected NZP CSI-RS exists in the case that a value of a field SRS request in a DCI format 0_1 or 1_1 is not ‘00’. In this case, the corresponding DCI should not indicate cross carrier or cross BWP scheduling. Further, when a value of the SRS request indicates existence of the NZP CSI-RS, the corresponding NZP CSI-RS is located in a slot in which the PDCCH including the SRS request field is transmitted. In this case, TCI states configured to the scheduled subcarriers are not configured to QCL-TypeD.

When a periodic or semi-persistent SRS resource set is configured, the connected NZP CSI-RS may be indicated through associatedCSI-RS in an SRS-ResourceSet, which is higher signaling. For non-codebook based transmission, the UE does not expect that spatialRelationInfo, which is higher signaling for an SRS resource and associatedCSI-RS in SRS-ResourceSet, which is higher signaling are configured together.

In the case that the UE are configured with a plurality of SRS resources, the UE may determine a precoder and transmission rank to be applied to PUSCH transmission based on the SRI indicated by the base station. In this case, the SRI may be indicated through a field SRS resource indicator in DCI or may be configured through a srs-ResourceIndicator, which is higher signaling. Similar to the above-described codebook-based PUSCH transmission, in the case that the UE receives an SRI through DCI, the SRS resource indicated by the corresponding SRI means an SRS resource corresponding to the SRI among SRS resources transmitted earlier than the PDCCH including the corresponding SRI. The UE may use one or a plurality of SRS resources for SRS transmission, and the number of maximum SRS resources that may be simultaneously transmitted in the same symbol within one SRS resource set and the number of maximum SRS resources are determined by a UE capability reported by the UE to the base station. In this case, SRS resources transmitted simultaneously by the UE occupy the same RB. The UE configures one SRS port for each SRS resource. An SRS resource set in which a value of usage in the SRS-ResourceSet, which is higher signaling is configured to ‘nonCodebook’ may be configured to only one, and SRS resources for non-codebook based PUSCH transmission may be configured to maximum four.

The base station transmits one NZP-CSI-RS connected to the SRS resource set to the UE, and the UE calculates a precoder to use when transmitting one or a plurality of SRS resources in the corresponding SRS resource set based on the measured result upon receiving the corresponding NZP-CSI-RS. The UE applies the calculated precoder when transmitting one or a plurality of SRS resources in the SRS resource set in which the usage is configured to ‘nonCodebook’ to the base station, and the base station selects one or a plurality of SRS resources among one or a plurality of received SRS resources. In this case, in non-codebook based PUSCH transmission, the SRI indicates an index capable of expressing a combination of one or a plurality of SRS resources, and the SRI is included in DCI. In this case, the number of SRS resources indicated by the SRI transmitted by the base station may be the number of transmission layers of the PUSCH, and the UE applies a precoder applied to transmission of the SRS resource to each layer to transmit the PUSCH.

### PUSCH: Preparation Procedure Time

Hereinafter, a PUSCH preparation procedure time will be described. In the case that the base station schedules the UE to transmit a PUSCH using a DCI format 0_0, 0_1, or 0_2, the UE may apply a transmission method (transmission precoding method of SRS resource, number of transmission layers, spatial domain transmission filter) indicated through DCI to require a PUSCH preparation procedure time for transmitting the PUSCH. NR defined a PUSCH preparation procedure time considering this. The PUSCH preparation procedure time of the UE may follow Equation 2.

$${T}_{proc , 2} = max ( ( {N}_{2} + {d}_{2 , 1} + {d}_{2} ) ( 2048 + 1 \; 44 ) {κ2}^{- µ} {T}_{c} + {T}_{ext} + {T}_{switch} , {d}_{2 , 2} ) \qquad Equation 2$$

In T_{proc,2} described above with Equation 2, each variable may have the following meaning.
N₂: The number of symbols determined according to numerology u and an UE processing capability 1 or 2 according to a UE capability. In the case of being reported as UE processing capability 1 according to a capability report of the UE, N₂ has a value of Table 22, and in the case of being reported as a UE processing capability 2 and being configured through higher layer signaling that the UE processing capability 2 may be used, N₂ may have a value of Table 23.

TABLE 22

| | PUSCH preparation time N₂ |
|---|---|
| μ | [symbols] |
| 0 | 10 |
| 1 | 12 |
| 2 | 23 |
| 3 | 36 |

TABLE 23

| | PUSCH preparation time N₂ |
|---|---|
| μ | [symbols] |
| 0 | 5 |
| 1 | 5.5 |
| 2 | 11 for frequency range 1 |

d_{2,1}: d_{2,1} is 0 in the case that all resource elements of a first OFDM symbol of PUSCH transmission are configured to be composed of only DM-RS, and otherwise, d_{2,1} is the number of symbols determined to 1.
κ: 64
μ: μ follows a value in which T_{proc,2} becomes larger in μ_{DL} or μ_{UL}. μ_{DL} denotes numerology of a downlink through which a PDCCH including DCI scheduling a PUSCH is transmitted, and JUL denotes numerology of an uplink through which a PUSCH is transmitted.
T_{c}: 1/(Δfₘₐₓ*N_{f}), Δfₘₐₓ=480*10³ Hz, N_{f}=4096.
d_{2,2}: d_{2,2} follows a BWP switching time in the case that DCI scheduling the PUSCH indicates BWP switching, otherwise, d_{2,2} has 0.
d₂: In the case that OFDM symbols of a PUCCH and a PUSCH with a high priority index and a PUCCH with a low priority index overlap in time, a de value of the PUSCH with a high priority index is used. Otherwise, d₂ is 0.
Tₑₓₜ: In the case that the UE uses a shared spectrum channel access method, the UE may calculate a Tₑₓₜ and apply the Tₑₓₜ to the PUSCH preparation procedure time. Otherwise, the Tₑₓₜ is assumed as 0.
T_{switch}: In the case that an uplink switching interval is triggered, T_{switch} is assumed as a switching interval time. Otherwise, T_{switch} is assumed as 0.

When the base station and the UE consider time axis resource mapping information of a PUSCH scheduled through DCI and the effect of timing advance between the uplink and downlink, in the case that a first symbol of a PUSCH starts earlier than a first uplink symbol in which a CP starts after T_{proc,2} from a last symbol of the PDCCH including DCI that schedules the PUSCH, the base station and the UE determine that a PUSCH preparation procedure time is not sufficient. Otherwise, the base station and the UE determine that the PUSCH preparation procedure time is sufficient. The UE may transmit the PUSCH only in the case that the PUSCH preparation procedure time is sufficient, and ignore DCI scheduling the PUSCH in the case that the PUSCH preparation procedure time is not sufficient.

### Related to CA/DC

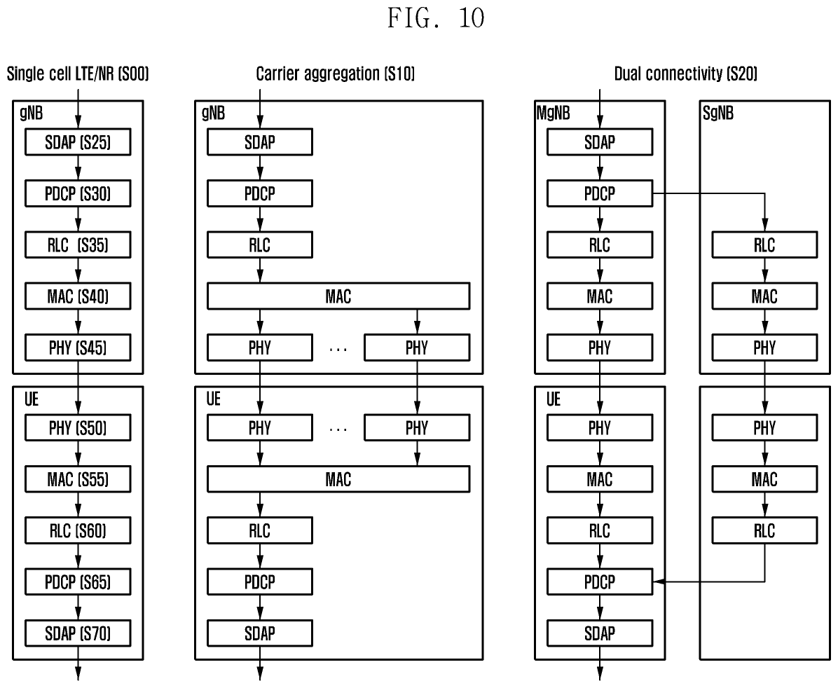

FIG. 10 is a block diagram illustrating a radio protocol structure of a base station and a UE in a single cell, carrier aggregation, and dual connectivity situation according to an embodiment of the disclosure.

Referring to FIG. 10, radio protocols of a next generation mobile communication system include NR service data adaptation protocols (SDAPs) S25 and S70, NR packet data convergence protocols (PDCPs) S30 and S65, NR radio link controls (RLCs) S35 and S60, and NR medium access controls (MACs) S40 and S55 in the UE and the NR base station, respectively.

Main functions of the NR SDAPs S25 and S70 may include some of the following functions.
transfer of user plane data
mapping between a QoS flow and a DRB for both DL and UL
marking QoS flow ID in both DL and UL packets
reflective QoS flow to DRB mapping for the UL SDAP PDUs.

For the SDAP layer device, the UE may receive a configuration on whether to use a header of the SDAP layer device or whether to use a function of the SDAP layer device for each PDCP layer device, each bearer, or each logical channel with a radio resource control (RRC) message, and in the case that the SDAP header is configured, the UE may instruct non-access stratum (NAS) reflective quality of service (QOS) and access stratum (AS) reflective QoS of the SDAP header to update or reconfigure mapping information on uplink and downlink QoS flows and data bearers. The SDAP header may include QoS flow ID information indicating a QoS. The QoS information may be used as a data processing priority and scheduling information for supporting a smooth service.

Main functions of the NR PDCPs S30 and S65 may include some of the following functions.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink.

In the above description, reordering of the NR PDCP device may refer to a function of reordering PDCP PDUs received from a lower layer based on a PDCP sequence number (SN) and include a function of transferring data to a higher layer in the rearranged order. Alternatively, the reordering of the NR PDCP device may include a function of directly transferring data without considering the order, a function of rearranging the order and recording lost PDCP PDUs, a function of reporting a status of lost PDCP PDUs to the transmitting side, and a function of requesting retransmission of lost PDCP PDUs.

Main functions of the NR RLCs S35 and S60 may include some of the following functions.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

In the above description, in-sequence delivery of the NR RLC device may mean a function of sequentially transferring RLC SDUs received from a lower layer to a higher layer. In-sequence delivery of the NR RLC device may include a function of reassembling and transferring several RLC SDUs in the case that an original RLC SDU is divided into several RLC SDUs and received, a function of rearranging received RLC PDUs based on an RLC sequence number (SN) or a PDCP sequence number (SN), a function of rearranging the order and recording lost RLC PDUs, a function of reporting a status of lost RLC PDUs to the transmitting side, and a function of requesting retransmission of lost RLC PDUs. In-sequence delivery of the NR RLC device may include a function of sequentially transferring, in the case that there is a lost RLC SDU, only RLC SDUs before the lost RLC SDU to a higher layer or a function of sequentially transferring all RLC SDUs received before the timer starts to the higher layer, when a predetermined timer has expired even if there is a lost RLC SDU. Alternatively, in-sequence delivery of the NR RLC device may include a function of sequentially transferring all RLC SDUs received so far to the higher layer, when a predetermined timer has expired even if there is a lost RLC SDU. Further, the RLC PDUs may be processed in the order of reception (regardless of order of serial numbers and sequence numbers, in order of arrival) and transferred to the PDCP device regardless of order (out-of sequence delivery), and in the case of a segment, the NR RLC device may receive segments stored in a buffer or to be received later, reconstitute segments into one complete RLC PDU, and then transfer the one complete RLC PDU to the NR PDCP device. The NR RLC layer may not include a concatenation function, and the NR MAC layer may perform the concatenation function or the concatenation function may be replaced with a multiplexing function of the NR MAC layer.

In the above description, out-of-sequence delivery of the NR RLC device may mean a function of directly transferring RLC SDUs received from a lower layer to a higher layer regardless of order and may include a function of reassembling and transferring several RLC SDUs in the case that an original RLC SDU is divided into several RLC SDUs and received and a function of storing RLC SNs or PDCP sequence numbers (SNs) of received RLC PDUs, arranging the order, and recording lost RLC PDUS.

The NR MACs S40 and S55 may be connected to several NR RLC layer devices constituted in one UE, and main functions of the NR MAC may include some of the following functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR PHY layers S45 and S50 may perform operations of channel-coding and modulating higher layer data, making the higher layer data into OFDM symbols and transmitting the OFDM symbols through a radio channel, or demodulating OFDM symbols received through a radio channel, channel-decoding the OFDM symbols, and transferring the OFDM symbols to a higher layer.

A detailed structure of the radio protocol structure may be variously changed according to a carrier (or cell) operation method. For example, in the case that the base station transmits data to the UE based on a single carrier (or cell), the base station and the UE use a protocol structure having a single structure for each layer, as in S00. In the case that the base station transmits data to the UE based on carrier aggregation (CA) using multiple carriers in a single TRP, the base station and the UE have a single structure up to RLC, as in S10, but use a protocol structure for multiplexing the PHY layer through the MAC layer. As another example, in the case that the base station transmits data to the UE based on dual connectivity (DC) using multiple carriers in multiple TRPs, the base station and the UE have a single structure up to RLC, as in S20, but use a protocol structure for multiplexing the PHY layer through the MAC layer.

With reference to the descriptions related to the above-described PDCCH and beam configuration, it is difficult to achieve required reliability in scenarios requiring high reliability such as URLLC because PDCCH repetition transmission is not currently supported in Rel-15 and Rel-16 NRs. In the disclosure, a PDCCH repetition transmission method through multiple transmission points (TRPs) is provided to improve PDCCH reception reliability of the UE. Specific methods thereof are specifically described in the following examples.

Hereinafter, embodiments of the disclosure will be described in detail with accompanying drawings. The contents of the disclosure are applicable to FDD and TDD systems. Hereinafter, higher signaling (or higher layer signaling) in the disclosure is a method of transmitting a signal from a base station to a UE using a downlink data channel of a physical layer, or from a UE to a base station using an uplink data channel of a physical layer and may also be referred to as RRC signaling, PDCP signaling, or a medium access control (MAC) control element (MAC CE).

Hereinafter, in the disclosure, in determining whether cooperative communication is applied, the UE may use various methods in which a PDCCH(s) allocating a PDSCH to which cooperative communication is applied has (have) a specific format, or in which a PDCCH(s) allocating a PDSCH to which cooperative communication is applied include(s) a specific indicator indicating whether communication is applied, or in which a PDCCH(s) allocating a PDSCH to which cooperative communication is applied is (are) scrambled with specific RNTI, or in which cooperative communication application is assumed in a specific segment indicated by a higher layer, and the like. Hereinafter, for convenience of description, the case that the UE receives the PDSCH to which cooperative communication is applied based on conditions similar to the above description will be referred to as an NC-JT case.

Hereinafter, in the disclosure, determining a priority between A and B may be variously referred to as selecting one having a higher priority according to a predetermined priority rule and performing a corresponding operation or omitting or dropping an operation for one having a lower priority.

Hereinafter, in the disclosure, the examples are described through a plurality of embodiments, but they are not independent, and one or more embodiments may be applied simultaneously or in combination.

Hereinafter, embodiments of the disclosure will be described in detail with accompanying drawings. Hereinafter, the base station is a subject performing resource allocation of a UE, and may be at least one of a gNode B, a gNB, an eNode B, a node B, a base station (BS), a radio access unit, a base station controller, or a node on a network. The terminal may include a user equipment (UE), a mobile station (MS), a cellular phone, a smart phone, a computer, or a multimedia system capable of performing a communication function. Hereinafter, an embodiment of the disclosure is described using a 5G system as an example, but the embodiment of the disclosure may be applied to other communication systems having a similar technical background or channel type. For example, LTE or LTE-A mobile communication and mobile communication technology developed after 5G may be included therein. Accordingly, the embodiments of the disclosure may be applied to other communication systems through some modification without significantly departing from the scope of the disclosure by determination of a person skilled in the art. The contents of the disclosure are applicable to FDD and TDD systems.

Further, in describing the disclosure, in the case that it is determined that a detailed description of a related function or constitution may unnecessarily obscure the gist of the disclosure, a detailed description thereof will be omitted. Terms described below are terms defined in consideration of functions in the disclosure, which may vary according to intentions or customs of users and operators. Therefore, the definition should be made based on the content throughout this specification.

Hereinafter, in describing the disclosure, higher layer signaling may be signaling corresponding to at least one or a combination of one or more of the following signaling.
MIB (Master Information Block)
SIB (System Information Block) or SIB X (X=1, 2, . . . )
RRC (Radio Resource Control)
MAC (Medium Access Control) CE (Control Element)

Further, L1 signaling may be signaling corresponding to at least one or a combination of one or more of signaling methods using the following physical layer channels or signaling.
PDCCH (Physical Downlink Control Channel)
DCI (Downlink Control Information)
UE-specific DCI
Group common DCI
Common DCI
Scheduling DCI (e.g., DCI used for the purpose of scheduling downlink or uplink data)
Non-scheduling DCI (e.g., DCI that is not for the purpose of scheduling downlink or uplink data)
PUCCH (Physical Uplink Control Channel)
UCI (Uplink Control Information)

Hereinafter, in the disclosure, determining a priority between A and B may be variously referred to as selecting one having a higher priority according to a predetermined priority rule and performing a corresponding operation or omitting or dropping an operation for one having a lower priority.

Hereinafter, in the disclosure, the examples are described through a plurality of embodiments, but they are not independent, and one or more embodiments may be applied simultaneously or in combination.

### Related to SBFD

In 3GPP, a subband non-overlapping full duplex (SBFD) is being discussed with a new duplex method based on NR. The SBFD is technology that receives uplink transmission from the UE as much as increased uplink resources to expand uplink coverage of the UE by utilizing a part of downlink resources as uplink resources in a TDD spectrum of frequencies of 6 GHz or less or 6 GHz or more and that receives feedback on downlink transmission from the UE in the expanded uplink resources, thereby reducing a feedback delay. In the disclosure, a UE that may receive information on whether to support an SBFD from the base station and that may perform uplink transmission in a part of downlink resources may be referred to as an SBFD UE (SBFD-capable UE) for convenience. The following methods may be considered to define the SBFD method in the standard and in order for the SBFD UE to determine that the SBFD is supported in a specific cell (or frequency, frequency band).

First method. In addition to the existing unpaired spectrum (or time division duplex (TDD)) or paired spectrum (or frequency division duplex (FDD)) frame structure type, another frame structure type (e.g., frame structure type 2) may be introduced to define the above SBFD. The above frame structure type 2 may be defined as being supported at the specific frequency or frequency band, or the base station may instruct to the UE whether to support an SBFD through system information. The SBFD UE may receive system information including whether to support an SBFD and determine whether to support an SBFD in the specific cell (or frequency, frequency band).

Second method. It may be indicated whether to additionally support the SBFD at a specific frequency or frequency band of the existing unpaired spectrum (or TDD) without defining a new frame structure type. In the second method, it may be defined whether to additionally support the SBFD at a specific frequency or frequency band of the existing unpaired spectrum, or the base station may instruct to the UE whether to support an SBFD through system information. The SBFD UE may receive system information including whether to support an SBFD to determine whether to support an SBFD in the specific cell (or frequency, frequency band).

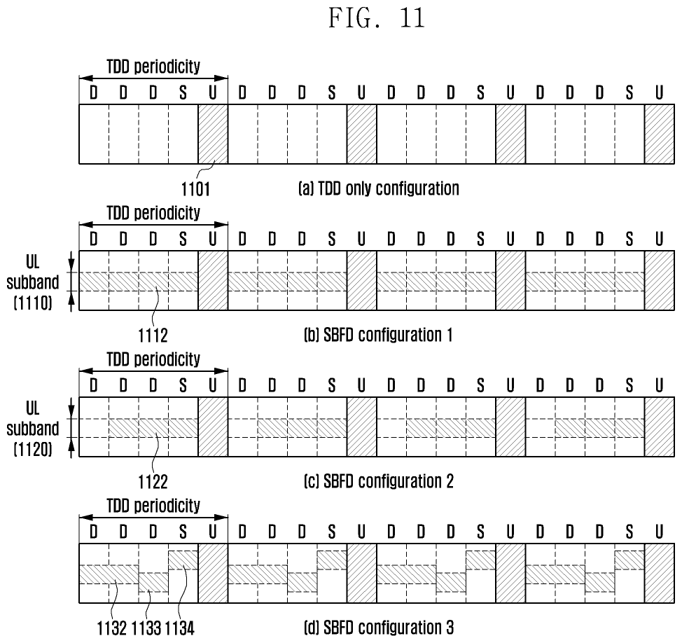

Information on whether to support an SBFD in the first and second methods may be information indicating whether to indirectly support an SBFD (e.g., SBFD resource constitution information in FIG. 11 to be described later) by additionally configuring a part of the downlink resource as an uplink resource in addition to a configuration on TDD UL (uplink)-DL (downlink) resource constitution information indicating TDD downlink slot (or symbol) resources and uplink slot (or symbol) resources or may be information indicating whether to directly support an SBFD.

In the disclosure, the SBFD UE may receive a synchronization signal block at initial cell access for accessing a cell (or base station) to acquire cell synchronization. A process of acquiring cell synchronization may be the same in the SBFD UE and the existing TDD UE. Thereafter, the SBFD UE may determine whether the cell supports an SBFD through MIB acquisition, SIB acquisition, or a random access process.

System information for transmitting information on whether to support the SBFD may be system information to be transmitted separately from system information for a UE (e.g., existing TDD UE) supporting a different version of the standard within a cell, and the SBFD UE may acquire all or part of system information to be transmitted separately from system information for the existing TDD UE to determine whether to support the SBFD. In the case that the SBFD UE acquires only system information for the existing TDD UE or acquires system information on non-support of an SBFD, the SBFD UE may determine that the cell (or base station) supports only a TDD.

In the case that information on whether to support the SBFD is included in system information for a UE (e.g., existing TDD UE) supporting a different version of the standard, the information on whether to support the SBFD may be inserted at the very end so as to have no effect on acquisition of system information of the existing TDD UE. In the case that the SBFD UE fails to acquire last inserted information on whether to support the SBFD or acquires information that the SBFD is not supported, the SBFD UE may determine that the cell (or base station) supports only a TDD.

In the case that information on whether to support the SBFD is included in system information for a UE (e.g., existing TDD UE) supporting a different version of the standard, information on whether to support the SBFD may be transmitted with a separate PDSCH so as to have no effect on acquisition of system information of the existing TDD UE. That is, a UE that does not support an SBFD may receive a first SIB (or SIB1) including existing TDD related system information from a first PDSCH. A UE supporting an SBFD may receive a first SIB (or SIB) including existing TDD related system information from the first PDSCH, and receive a second SIB including SBFD related system information from a second PDSCH. Here, the first PDSCH and the second PDSCH may be scheduled by a first PDCCH and a second PDCCH, and a cyclic redundancy code (CRC) of the first PDCCH and the second PDCCH may be scrambled with the same RNTI (e.g., SI-RNTI). A search space for monitoring the second PDCCH may be acquired from system information of the first PDSCH, and if a search space for monitoring the second PDCCH is not acquired (i.e., if system information of the first PDSCH does not include information on a search space), the second PDCCH may be received in the same search space as that of the first PDCCH.

As described above, in the case that the SBFD UE determines that the cell (or base station) supports only a TDD, the SBFD UE may perform random access procedures and data/control signal transmission and reception in the same way as that of an existing TDD UE.

The base station may constitute a separate random access resource for each of the existing TDD UEs or SBFD UEs (e.g., an SBFD UE supporting duplex communication and an SBFD UE supporting half-duplex communication), and transmit constitution information (control information or constitution information indicating time-frequency resources that may be used for a PRACH) for the random access resource to the SBFD UE through system information. System information for transmitting information on the random access resource may be separately transmitted system information different from system information for a UE (e.g., existing TDD UE) supporting a different version of the standard within a cell.

The base station may configure separate random access resources to the SBFD UE and the TDD UE supporting a different version of the standard to distinguish whether the TDD UE supporting the different version of the standard performs random access or the SBFD UE performs random access. For example, a separate random access resource configured for the SBFD UE may be a resource in which the existing TDD UE determines as a downlink time resource, and the SBFD UE may perform random access through an uplink resource (or a separate random access resource) configured to some frequencies of the downlink time resource; thus, the base station may determine that a UE that has attempted random access in the uplink resource is an SBFD UE.

Alternatively, the base station may configure a common random access resource to all UEs in the cell without configuring a separate random access resource for the SBFD UE. In this case, constitution information on the random access resource may be transmitted to all UEs in the cell through system information, and the SBFD UE that has received the system information may perform random access to the random access resource. Thereafter, the SBFD UE may complete a random access process and proceed in an RRC connection mode for transmitting and receiving data to and from the cell. After the RRC access mode, the SBFD UE may receive, from the base station, an upper or physical signal that may determine that some frequency resources of the downlink time resource are configured as uplink resources and perform an SBFD operation, for example, transmit an uplink signal in the uplink resource.

In the case that the SBFD UE determines that the cell supports an SBFD, the SBFD UE may transmit capability information including at least one of information on whether the UE supports an SBFD, information on whether the UE supports full-duplex communication or half-duplex communication, or the number of transmission or reception antennas in which the UE has (or supports) to the base station, thereby notifying the base station that the UE attempting to access is an SBFD UE. Alternatively, in the case that half-duplex communication support is required for the SBFD UE, whether the half-duplex communication is supported may be omitted from capability information. Reporting of the SBFD UE on the capability information may be performed to the base station through a random access process, be performed to the base station after completing the random access process, or be performed to the base station after proceeding in an RRC connection mode for transmitting and receiving data to and from cells.

The SBFD UE may support half-duplex communication that performs only uplink transmission or downlink reception at a single moment, as in an existing TDD UE, or the SBFD UE may support full-duplex communication that performs both uplink transmission and downlink reception at a single moment. Therefore, the SBFD UE may report information on whether the SBFD UE supports half-duplex communication or full-duplex communication to the base station through capability reporting, and after the reporting, the base station may configure to the SBFD UE whether the SBFD UE will transmit and receive using half-duplex communication or full-duplex communication. In the case that the SBFD UE reports the capability for half-duplex communication to the base station, a duplexer does not generally exist; thus, a switching gap for changing an RF may be required between transmission and reception in the case of operating in FDD or TDD.

FIG. 11 is a diagram illustrating an example of operating an SBFD in a TDD band of a wireless communication system to which the disclosure is applied according to an embodiment of the disclosure.

Part (a) of FIG. 11 illustrates the case that a TDD is operated in a specific frequency band. In a cell operating the TDD, the base station may transmit and receive signals including data/control information in a downlink slot (or symbol), an uplink slot (or symbol) 1101, and a flexible slot (or symbol) to and from the existing TDD UE or SBFD UE based on a configuration on TDD UL-DL resource constitution information indicating TDD downlink slot (or symbol) resources and uplink slot (or symbol) resources.

In FIG. 11, it may be assumed that a DDDSU slot format is configured according to TDD UL-DL resource constitution information. Here, ‘D’ is a slot composed of all downlink symbols, ‘U’ is a slot composed of all uplink symbols, and ‘S’ is a slot other than ‘D’ or ‘U’, that is, a slot including a downlink symbol to an uplink symbol or including a flexible symbol. Here, for convenience, it may be assumed that S is composed of 12 downlink symbols and 2 flexible symbols. The DDDSU slot format may be repeated according to TDD UL-DL resource constitution information. That is, a repetition period of a TDD configuration is 5 slots (5 ms in the case of 15 kHz SCS, 2.5 ms in the case of 30 KHz SCS, and the like).

Thereafter, parts (b), (c), and (d) of FIG. 11 illustrate the case that an SBFD is operated with a TDD in a specific frequency band.

Referring to part (b) of FIG. 11, the UE may receive a configuration of some frequency bands of frequency bands of the cell to a frequency band 1110 capable of transmitting an uplink. This band may be referred to as an uplink subband (UL subband). The uplink subband (UL subband) may be applied to all symbols of all slots. The UE may transmit uplink channels or signals scheduled to all symbols 1112 within the subband (UL subband). However, the UE may not transmit an uplink channel or signal in a band other than the UL subband.

Referring to part (c) of FIG. 11, the UE may be configured with some of frequency bands of the cell as a frequency band 1120 capable of transmitting an uplink and be configured with a time domain in which the frequency band is activated. Here, this frequency band may be referred to as an uplink subband (UL subband). In part (c) of FIG. 11, an uplink subband (UL subband) was deactivated in a first slot, and an uplink subband (UL subband) may be activated in the remaining slots. Accordingly, the UE may transmit an uplink channel or signal in an uplink subband (UL subband) 1122 of the remaining slots. Therefore, here, the uplink subband (UL subband) was activated in units of a slot, but activation of the uplink subband (UL subband) may be configured in units of a symbol.

Referring to part (d) of FIG. 11, the UE may be configured with a time-frequency resource capable of transmitting an uplink. The UE may be configured with one or more time-frequency resources as time-frequency resources capable of transmitting an uplink. For example, the UE may be configured with some frequency bands 1132 of a first slot and a second slot to time-frequency resources capable of transmitting an uplink. Further, the UE may be configured with some frequency bands 1133 of a third slot and some frequency bands 1134 of a fourth slot to time-frequency resources capable of transmitting an uplink.

In the following description, a time-frequency resource capable of transmitting an uplink within a downlink symbol or slot may be referred to as an SBFD resource. A symbol in which an uplink subband is configured within a downlink symbol may be referred to as an SBFD symbol. Further, a time-frequency resource capable of receiving a downlink within an uplink symbol or slot may be referred to as an SBFD resource. A symbol in which a downlink subband is configured within the uplink symbol may be referred to as an SBFD symbol.

For convenience, in the disclosure, a band capable of receiving a downlink channel or signal excluding an uplink subband is referred to as a downlink subband. The UE may configure maximum one uplink subband and maximum two downlink subbands in one symbol. For example, the UE may be configured with one of {uplink subband, downlink subband}, {downlink subband, uplink subband}, or {first downlink subband, uplink subband, second downlink subband) in the frequency domain.

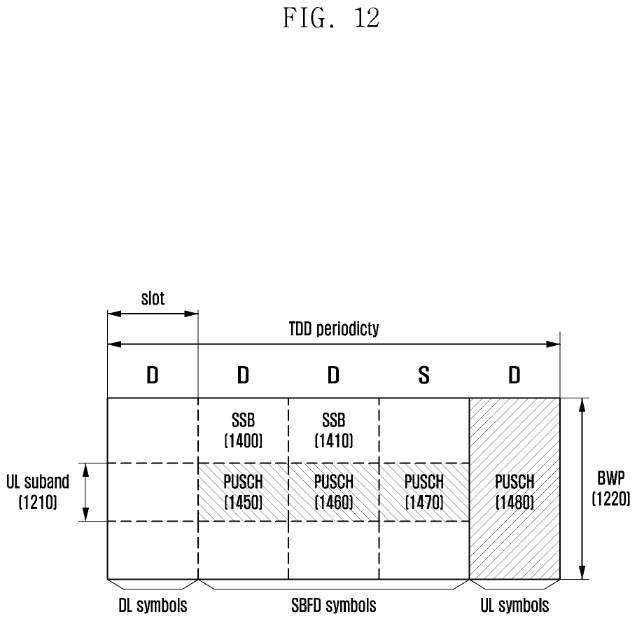

FIG. 12 is used for describing according to an embodiment of the disclosure. FIG. 12 illustrates an example, and this embodiment may be equally applied to other embodiments.

Referring to FIG. 12, the UE may be configured with an uplink symbol, a downlink symbol, or a flexible symbol according to a TDD configuration. Here, a slot ‘D’ indicates a slot in which all symbols in the slot are downlink symbols. A slot ‘U’ indicates a slot in which all symbols in the slot are uplink symbols. A slot ‘S’ indicates a slot other than a slot ‘D’ or a slot ‘U’. The UE may be configured with an UL BWP 1220. The UE may be configured with an UL subband 1210 within the DL symbol. In this embodiment, it is assumed that the UL BWP includes 275 RBs and that the UL subband includes 50 RBs. It is assumed that the UL subband is not configured in a first slot. Therefore, the first slot is referred to as a DL slot, and a symbol included in the first slot is referred to as a DL symbol. It is assumed that the UL subband is configured in second, third, and fourth slots. Therefore, the second, third, and fourth slots are referred to as SBFD slots, and symbols included in the second, third, and fourth slots are referred to as SBFD symbols. A fifth slot is referred to as an uplink slot, and symbols included in the fifth slot are referred to as UL symbols.

### UE-UE CLI Occurrence and Mitigation Methods

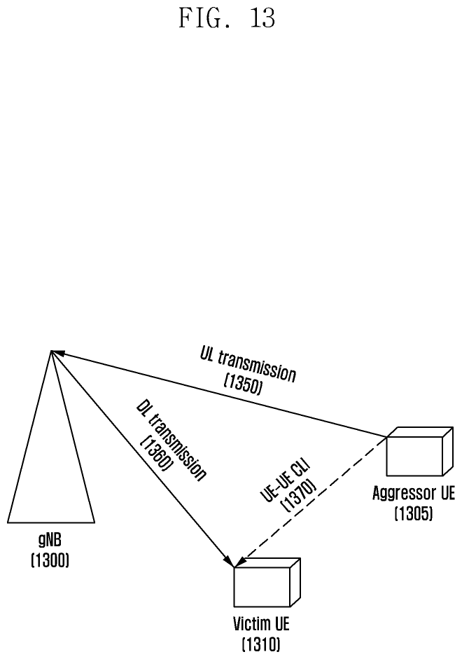

FIG. 13 illustrates a scenario in which UE-UE CLI occurs according to an embodiment of the disclosure.

Referring to FIG. 13, a base station 1300 supporting an SBFD may use some frequency bands among the same time resources for downlink transmission and use some other frequency bands for uplink reception. In the same time resource (symbol), some UE 1305 among UEs within one cell may receive scheduling of uplink transmission 1350. Another UE 1310 may receive scheduling of downlink reception 1360. Therefore, uplink transmission of the UE (aggressor UE) 1305 scheduled for uplink transmission affects as interference (UE-UE cross link interference (CLI)) 1370 in downlink reception of the UE (victim UE) 1310 scheduled for downlink reception. Such interference may cause a problem that deteriorates a quality of downlink reception. In the following description, the uplink UE represents the UE 1305 scheduled for uplink transmission, and the downlink UE represents the UE 1310 scheduled for downlink transmission.

When scheduling the uplink, the base station may schedule the uplink in consideration of UE-UE CLI. For example, in the case that the UE-UE CLI influence of the uplink UE on the downlink UE is large, the base station may schedule the uplink UE to a different time resource (symbol) or configure the uplink UE to transmit with low transmit power. Further, in consideration of the influence of UE-UE CLI, the base station may schedule the downlink with a lower code rate to the downlink UE, schedule the downlink with higher transmit power, or schedule the downlink to a different time resource (symbol), thereby improving a reception quality of a downlink channel and signal.

In this way, in order for the base station to perform scheduling in consideration of UE-UE CLI, UE-UE CLI measurement and reporting between the uplink UE and the downlink UE are required. That is, the base station needs to configure a measurement signal (e.g., SRS) for measuring UE-UE CLI to the uplink UE and downlink UE, and configure a PUCCH or PUSCH for reporting the measured UE-UE CLI. Further, such UE-UE CLI measurement and reporting should be applied to all uplink UE and downlink UE pairs within the cell. Therefore, a high system overhead may occur.

Further, in the case that the UE is not in an RRC connected state (a state in which the UE has received an RRC configuration after random access), for example, in the case that the UE is in an RRC idle state, the base station may not predict when the UE will receive a downlink channel and signal and when the UE will transmit an uplink channel and signal. For example, the UE in the RRC idle state may receive an SSB, which is the downlink channel and signal in order to change the RRC idle state to the RRC connected state. Further, the UE in the RRC idle state may transmit a PRACH in a RACH occasion in order to change the RRC idle state to the RRC connected state. Because SSB reception and transmission in the RACH occasion of the UE in the RRC idle state may not be indicated/configured in advance by the base station, it may be difficult for the base station to predict SSB reception and transmission in the RACH occasion of the UE in the RRC idle state. For reference, the SSB and RACH occasion may be configured by the base station, but which SSB the UE measures and which RACH occasion the UE transmits are determined according to implementation of the UE.

Therefore, in the case that it is difficult for the base station to measure UE-UE CLI between all uplink UE and downlink UE pairs within a cell, and in the case of considering the RRC idle UE, it may be difficult for the base station to predict UE-UE CLI between uplink UE and downlink UE pairs.

In the disclosure, a method of solving the above problem is described.

The UE may determine transmit power according to a transmission symbol in which a PUSCH is scheduled. More specifically, the UE may divide symbols into two types such as a first transmission symbol type and a second transmission symbol type.

The first transmission symbol type may be symbols that may use maximum transmit power configured to the UE. The second transmission symbol type may be symbols that may use power lower than maximum transmit power configured to the UE.

As another method, the first transmission symbol type may be symbols that may use transmit power calculated by the UE. The second transmission symbol type may be symbols that should lower and transmit some power from transmit power calculated by the UE.

In the disclosure, the first transmission symbol type may be UL symbols or symbols included in a UL slot. In the disclosure, the second transmission symbol type may be SBFD symbols or symbols included in an SBFD slot (a symbol in which a subband is configured to at least one symbol).

In another method, the first transmission symbol to the second transmission symbol may be configured by the base station. That is, the base station may configure time domain allocation information on the first transmission symbol to the UE, the UE may determine first transmission symbols according to the configuration, and symbols excluding the first transmission symbols may be regarded as a second transmission symbol type. Alternatively, the base station may configure time domain allocation information on the second transmission symbol to the UE, and the UE may determine second transmission symbols according to the configuration, and symbols excluding the second transmission symbols may be regarded as a first transmission symbol type.

In the case that the symbol is a flexible symbol configured by a higher layer signal, the UE may determine and use the flexible symbol as one of an uplink symbol and a downlink symbol. An SBFD UE may determine and use the flexible symbol as an SBFD symbol. That is, the SBFD UE may determine and use the flexible symbol as one of an uplink symbol, a downlink symbol, and an SBFD symbol. Therefore, when determining a transmission type of the flexible symbol, ambiguity may occur. To eliminate the ambiguity, the UE may regard the flexible symbol as one transmission type in order to determine a transmission type of the symbol. As an example, in order to determine a transmission type of the symbol, the UE may regard the flexible symbol as the first transmission symbol type. As another example, the UE may regard the flexible symbol as a second transmission symbol type.

In another method, the determination (whether the first transmission symbol type or the second transmission symbol type) may be determined according to a configuration or indication of the base station. For example, the UE may receive a configuration of a transmission symbol type of the symbol from the base station through a higher layer signal. As another example, the UE may receive a configuration of a transmission symbol type of the symbol from a DCI format that schedules an uplink channel or signal. For example, a DCI format scheduling a PUSCH may include 1 bit, and if the 1 bit is 0, symbols in which the PUSCH is scheduled may be regarded as a first transmission symbol type (i.e., symbols transmitted based on configured maximum transmit power, or transmitted based on calculated transmit power), and if the bit is 1, symbols in which the PUSCH is scheduled may be regarded as a second transmission symbol type (i.e., symbols transmitted based on maximum transmit power lower than configured maximum transmit power or transmitted based on transmit power lower than calculated transmit power).

In an embodiment, separate closed-loop power control may be applied to the first transmission symbol type and the second transmission symbol type. For example, the UE may receive a DCI format from the base station. The DCI format may include closed-loop power control information. According to the closed-loop power control information or transmit power control command, the UE may adjust transmit power. For example, transmit power may be determined as power increased or decreased by X dB compared to power used in previous transmission. Here, X dB may be determined according to closed-loop power control information.

In the UE, a DCI format may include one of closed-loop power control information of a first transmission symbol type and closed-loop power control information of a second transmission symbol type. Which symbol type of closed-loop power control information is included in the DCI format may be determined as follows.

If an uplink channel (PUSCH, PUCCH) scheduled by the DCI format is located in the first transmission symbol type, the UE may determine closed-loop power control information included in the DCI format as closed-loop power control information of the first transmission symbol type. If an uplink channel (PUSCH, PUCCH) scheduled by the DCI format is located in the second transmission symbol type, the UE may determine closed-loop power control information included in the DCI format as closed-loop power control information of the second transmission symbol type. That is, the UE may determine a transmission symbol type of closed-loop power control information based on a location in the time domain of the uplink channel scheduled by the DCI format.

In an embodiment, common closed-loop power control may be applied to the first transmission symbol type and the second transmission symbol type.

The DCI format may include closed-loop power control information to be commonly applied to the first and second transmission symbol types. In the case that an uplink channel scheduled by the DCI format is simultaneously scheduled to the first transmission symbol type and the second transmission symbol type, the UE may simultaneously apply closed-loop power control information included in the DCI format to the first transmission symbol type and the second transmission symbol type. For example, when PUSCH repetition transmission is scheduled through the DCI format, the PUSCH repetition transmission may be scheduled over the first transmission symbol type and the second transmission symbol type. In this case, closed-loop power control information included in the DCI format may be applied simultaneously to the first transmission symbol type and the second transmission symbol type.

### Embodiment 1 Determination of Maximum Transmit Power of PUSCH Overlapped with SSB

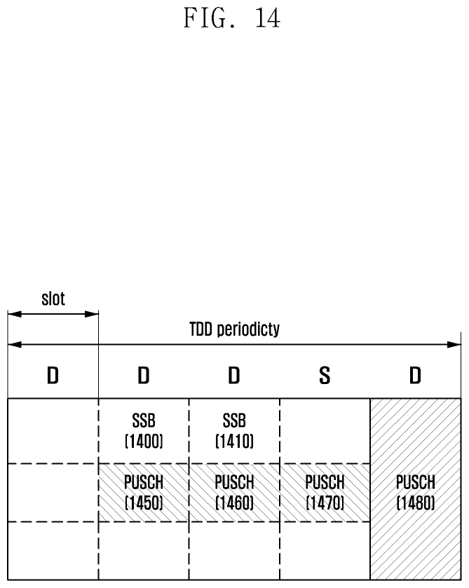

FIG. 14 illustrates an SSB configuration and PUSCH transmission in a cell in which an SBFD operation is configured according to an embodiment of the disclosure.

In the following description, an uplink is described based on a PUSCH for convenience, but embodiments of the disclosure may be extended to other uplink channels (e.g., PUCCH, SRS, and the like) with the same concept. Further, in the following description, a downlink is described based on an SSB for convenience, but embodiments of the disclosure may be extended to other downlink channels (e.g., PDCCH monitoring in common search space (Type-0), PDSCH transmitting SIB, SPS PDSCH, downlink channel having a high priority, and the like) with the same concept.

Referring to FIG. 14, the UE may configure SSBs 1400 and 1410 to two slots. Here, both slots may be slots in which an SBFD subband is configured. The UE may be configured to transmit PUSCHs 1450, 1460, 1470, and 1480 in four slots. Here, among four slots configured to transmit the PUSCHs 1450, 1460, 1470, and 1480, first three slots may be slots in which an SBFD subband is configured, and the last slot may be an uplink slot in which an SBFD subband is not configured. Among the previous three slots, two slots may be slots in which the SSBs 1400 and 1410 are configured, and the remaining one slot may be a slot in which an SSB is not configured.

In the case that an uplink UE transmits the PUSCHs 1450 and 1460 in a slot in which the SSBs 1400 and 1410 are configured, the uplink UE may affect UE-UE CLI to an adjacent downlink UE (particularly, an RRC idle UE that wants to receive an SSB). In this case, a downlink reception quality (particularly, a reception quality of an SSB) of a downlink UE may be deteriorated. To alleviate the influence of UE-UE CLI, the uplink UE may lower PUSCH transmit power.

For example, the UE may transmit a PUSCH using PUSCH transmit power lower by X dB than determined PUSCH transmit power. Here, X is a positive number and may be a value configured by the base station. However, in this case, because transmit power of the PUSCH is always reduced by X dB, a transmission quality of the PUSCH may be deteriorated.

As another method, maximum transmit power to be transmitted by the UE may be lowered. That is, because a PUSCH transmitting determined PUSCH transmit power to be lower than a certain level has less influence on UE-UE CLI, the UE does not reduce transmit power, but in the case that the determined PUSCH transmit power exceeds a certain level, the UE may reduce transmit power. In other words, the UE may determine PUSCH transmit power using maximum transmit power lower than generally used maximum transmit power P_{c,max}. Lower maximum transmit power is referred to as second maximum transmit power P_{c,max,2}, and generally used maximum transmit power is referred to as first maximum transmit power P_{c,max,1}. Here, second maximum transmit power may be characterized as being lower than first maximum transmit power. In general, PUSCH transmit power of the UE may be determined as follows.

PUSCH transmit power=min{P_{c,max,1},Pt}

Here, Pt may be a value determined according to open-loop power control, closed-loop power control, PUSCH resource allocation information, and modulation and coding scheme (MCS). That is, PUSCH transmit power may not always be greater than P_{c,max,1}.

To lower transmit power of a PUSCH, second maximum transmit power may be used. PUSCH transmit power determined using second maximum transmit power may be determined as follows.

PUSCH transmit power=min{P_{c,max,2},min{P_{c,max,1},Pt}} or

PUSCH transmit power=min{P_{c,max,2},Pt}}

That is, PUSCH transmit power may not always be greater than second transmit power.

For reference, second maximum transmit power P_{c,max,2} may be configured by the base station. The UE may receive a configuration of an absolute value of the second maximum transmit power P_{c,max,2} from the base station. Here, the absolute value may be a dB scale value. In another way, in order to determine a value of P_{c,max,2}, the UE may receive a configuration of a relative value with P_{c,max,1} from the base station. The relative value may be a dB scale value. The UE may determine a value reduced by a relative value configured in P_{c,max,1} as a value of P_{c,max,2}.

A configuration for P_{c,max,2} may be configured differently for each channel and signal. That is, a PUSCH, PUCCH, and SRS may have different configurations for P_{c,max,2}; thus, the PUSCH, PUCCH, and SRS may have different second transmit power values.

Referring to FIG. 14, transmit power of the PUSCHs 1450 and 1460 overlapped with SSB configurations 1400 and 1410 in the time domain may be determined based on a second transmit power value. The PUSCHs 1470 and 1480 that do not overlap with the SSB configuration in the time domain may be determined based on a first transmit power value.

According to an embodiment of the disclosure, a PUSCH located in a UL symbol or UL slot and a PUSCH located in an SBFD symbol (a symbol in which a subband is configured) or an SBFD slot (a slot in which a subband is configured) may use different transmit powers.

For example, a PUSCH located in the SBFD symbol or SBFD slot may transmit a PUSCH using PUSCH transmit power lower by X dB than PUSCH transmit power determined in a PUSCH located in the UL symbol or UL slot. Here, X is a positive number and may be a value configured by the base station. However, in this case, because transmit power of a PUSCH located in the SBFD symbol or SBFD slot is always reduced by X dB, a transmission quality of the PUSCH may be deteriorated.

As another method, maximum transmit power of a PUSCH located in the SBFD symbol or the SBFD slot to be transmitted by the UE may be lowered. That is, because a PUSCH located in the UL symbol or UL slot does not generate UE-UE CLI, the PUSCH uses high maximum transmit power, but a PUSCH located in the SBFD symbol or SBFD slot may generate UE-UE CLI; thus, the UE may reduce maximum transmit power for the PUSCH located in the SBFD symbol or SBFD slot.

Therefore, the UE may receive a configuration of three different maximum transmit powers. One maximum transmit power may be used for determining transmit power of a PUSCH located in the UL symbol or UL slot. Another maximum transmit power may be used for determining transmit power of a PUSCH that does not overlap with the downlink channel and signal among PUSCHs located in the SBFD symbol or SBFD slot. Another maximum transmit power may be used for determining transmit power of a PUSCH that overlaps the downlink channel and signal among PUSCHs located in the SBFD symbol or SBFD slot.

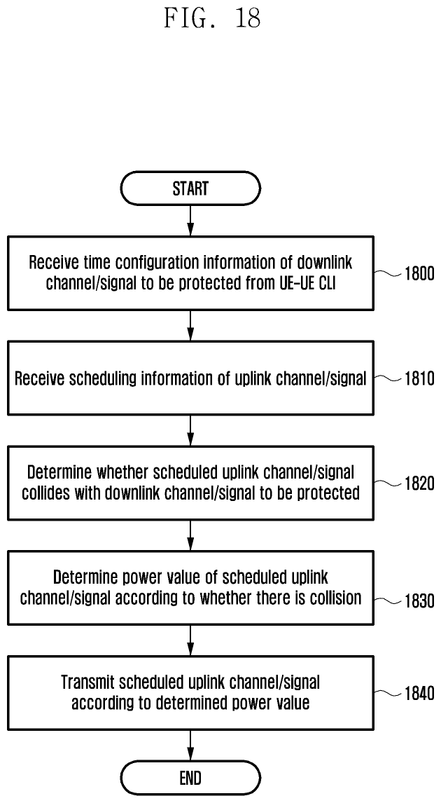

FIG. 18 is a flowchart according to an embodiment of the disclosure.

Referring to FIG. 18, a UE may receive time configuration information of a downlink channel and signal to be protected from UE-UE CLI from the base station, at operation 1800. For example, the UE may receive SSB configuration information from the base station, and regard an SSB according to the configuration as a downlink channel and signal to be protected. Further, the UE may receive a configuration of other downlink channels and signals (e.g., CSI-RS for tracking (TRS) or PDCCH corresponding to Type-0 common search space, and the like) as a downlink channel and signal to be protected.

The UE may receive uplink scheduling information from the base station, at operation 1810. The scheduled uplink channel and signal may be located inside an UL subband of the SBFD symbol or may be located within the UL symbol. The scheduled uplink channel and signal may include a PUSCH, PUCCH, PRACH, SRS, and the like.

The UE may determine whether there is a collision between a scheduled uplink channel and signal and a downlink channel and signal to be protected from UE-UE CLI, at operation 1820. Here, if the uplink channel and signal and the downlink channel and signal are located in the same symbol in the time domain, the UE may determine it as a collision. As another method, if the uplink channel and signal and the downlink channel and signal are located in the same time interval (e.g., slot) in the time domain, the UE may determine it as a collision.

The UE may determine a transmit power value of the uplink channel and signal according to whether there is a collision, at operation 1830. The UE may determine a transmit power value of an uplink channel and signal in which no collision has occurred using first maximum transmit power P_{c,max,1}. The UE may determine a transmit power value of an uplink channel and signal in which a collision has occurred using second maximum transmit power P_{c,max,2}. The second maximum transmit power P_{c,max,2} may be characterized as having a lower transmit power value compared to first maximum transmit power P_{c,max,1}.

The UE may transmit a scheduled uplink channel/signal according to the determined transmit power value, at operation 1840. Characteristically, the second maximum transmit power may be 0, and in this case, the UE may not transmit an uplink channel and signal.

### Embodiment 2 Determination of Maximum Transmit Power of RO within UL Subband

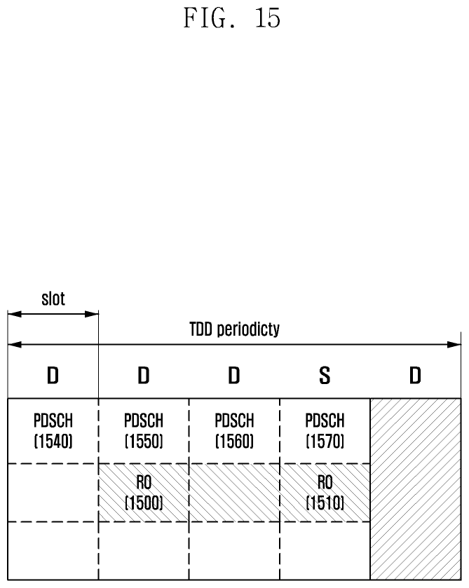

FIG. 15 illustrates RACH occasion (RO) configuration and PDSCH transmission in a cell in which an SBFD operation is configured according to an embodiment of the disclosure.

For convenience, the description is made based on a PDSCH, but embodiments of the disclosure may be extended to other downlink channels (e.g., PDCCH, CSI-RS, and the like) with the same concept. For convenience, the description is made based on a RACH occasion, but the embodiment of the disclosure may be extended to other uplink channels (CG PUSCH, and the like) with the same concept.

Referring to FIG. 15, the UE may configure ROs 1500 and 1510 in two slots. Here, both slots may be slots in which an SBFD subband is configured. The UE may be configured to receive PDSCHs 1540, 1550, 1560, and 1570 in four slots. Here, among four slots configured to receive the PDSCHs 1540, 1550, 1560, and 1570, the last three slots may be slots in which an SBFD subband is configured, and the first slot may be a downlink slot in which an SBFD subband is not configured. Among three slots in the back line, two slots may be slots in which an RO is configured, and the remaining one slot may be a slot in which an RO is not configured.

In the case that the downlink UE receives PDSCHs 1550 and 1570 in a slot in which an RO is configured, the downlink UE may receive UE-UE CLI from an adjacent uplink UE (particularly, an RRC idle UE transmitting a PRACH in an RO). In this case, a reception quality of a PDSCH of the downlink UE may be deteriorated. The problem is that an RRC idle UE may not know through which RO a PRACH will be transmitted. Further, when the RRC idle UE transmits a PRACH in the RO, in the case that the RRC idle UE does not receive a random access response (RAR), the RRC idle UE may increase and transmit transmit power of the PRACH. That is, in the case that the RRC idle UE transmits a PRACH through the RO, the base station may not configure, indicate, or change transmit power of the PRACH. A method for solving this is disclosed.

In an embodiment of the disclosure, in the case that the UE transmits a PRACH in an RO configured in an UL subband, the UE may reduce maximum transmit power of the PRACH. That is, in the case that the UE transmits a PRACH in an RO configured in an UL symbol or UL slot, maximum transmit power of a PRACH of an RO configured in the SBFD symbol or SBFD slot may be lower compared to maximum transmit power of the PRACH.

For example, the UE may transmit a PRACH in an RO located in the SBFD symbol or SBFD slot using PRACH transmit power lower by X dB than transmit power of the PRACH determined in an RO of the UL symbol or UL slot. Here, X is a positive number and may be a value configured by the base station. However, in this case, because transmit power of the PRACH is always reduced by X dB, a transmission quality of the PRACH may be deteriorated.

As another method, maximum transmit power transmitted by the UE may be lowered. In other words, the UE may determine transmit power of a PRACH of an RO located in the SBFD symbol or SBFD slot using lower maximum transmit power than generally used maximum transmit power P_{c,max}. Lower maximum transmit power is referred to as second maximum transmit power P_{c,max,2}, and generally used maximum transmit power is referred to as first maximum transmit power P_{c,max,1}. Here, second maximum transmit power may be characterized as being lower than first maximum transmit power. Transmit power of a PRACH of an RO located in the UL symbol or UL slot of the UE may be determined as follows.

PRACH transmit power=min{P_{c,max,1},Pt}

Here, Pt may be a value determined according to power ramping of a PRACH. In the case that the UE has transmitted a PRACH, but does not receive a random access response (RAR), the UE may increase transmit power of the PRACH according to power ramping. That is, transmit power located in the UL symbol or UL slot may not always be greater than P_{c,max,1}.

To lower transmit power of a PRACH of the RO located in the SBFD symbol or SBFD slot, second maximum transmit power may be used. PRACH transmit power determined using second maximum transmit power may be determined as follows.

PRACH transmit power=min{P_{c,max,2},min{P_{c,max,1},Pt}} or

PRACH transmit power=min{P_{c,max,2},Pt}}

That is, transmit power of a PRACH of an RO located in the SBFD symbol or SBFD slot may not always be greater than second transmit power.

For reference, second maximum transmit power P_{c,max,2} may be configured by the base station. The UE may receive a configuration of an absolute value of the second maximum transmit power P_{c,max,2} from the base station. Here, the absolute value may be a dB scale value. In another way, in order to determine a value of P_{c,max,2}, the UE may receive a configuration of a relative value with P_{c,max,1} from the base station. The relative value may be a dB scale value. The UE may determine a value reduced by a relative value configured in P_{c,max,1} as a value of P_{c,max,2}.

A configuration for P_{c,max,2} may be configured differently for each RO. That is, the UE may use larger P_{c,max,2} for some ROs of ROs located inside the SBFD symbol or SBFD slot, and use lower P_{c,max,2} for some other ROs. Furthermore, even in an RO located inside an SBFD symbol or SBFD slot, the UE may configure P_{c,max,2} to the same value as that of P_{c,max,1}.

In the case that the UE does not successfully receive an RAR, the UE should transmit a PRACH with higher power through a power ramping process. In the case that power determined through the power ramping process is less than P_{c,max,2}, the UE may perform one of the following operations.
Operation 1: In the case that an RO that has performed previous PRACH transmission is an RO located in an SBFD symbol or SBFD slot, the UE may select one of ROs located in the SBFD symbol or SBFD slot to transmit a PRACH with power determined according to power ramping. In the case that an RO that has performed previous PRACH transmission is an RO located in a UL symbol or UL slot, the UE may select one of ROs located in the UL symbol or UL slot to transmit a PRACH with power determined according to power ramping. However, in the case that an RO that has performed previous PRACH transmission is an RO located in the SBFD symbol or SBFD slot, the UE may select one of ROs located in the UL symbol or UL slot to transmit a PRACH with power determined according to power ramping. In the case that an RO that has performed previous PRACH transmission is an RO located in the UL symbol or UL slot, the UE may not select one of ROs located in the SBFD symbol or SBFD slot to transmit a PRACH with power determined according to power ramping. In other words, only PRACH retransmission may be allowed in an RO belonging to the same symbol type as a symbol type to which an RO that has performed previous PRACH transmission belongs.
Operation 2: In the case that an RO that has performed previous PRACH transmission is an RO located in the SBFD symbol or SBFD slot, the UE may select one RO among an RO located in the SBFD symbol or SBFD slot and an RO located in the UL symbol or UL slot to transmit a PRACH with power determined according to power ramping. In other words, PRACH retransmission may be possible in an RO belonging to the same symbol type as or a different symbol type from a symbol type to which an RO that has performed previous PRACH transmission belongs.

In the case that the UE does not successfully receive an RAR, the UE should transmit a PRACH with higher power through a power ramping process. In the case that power determined through the power ramping process is greater than P_{c,max,2} and smaller than P_{c,max,1}, the UE may not transmit a PRACH in an RO of the SBFD symbol or SBFD slot, but may transmit a PRACH in an RO of the UL symbol or UL slot. That is, the UE may not transmit a PRACH in an RO of an SBFD symbol or SBFD slot that should transmit with low power but may transmit a PRACH in an RO of a UL symbol or UL slot that may transmit with high power.

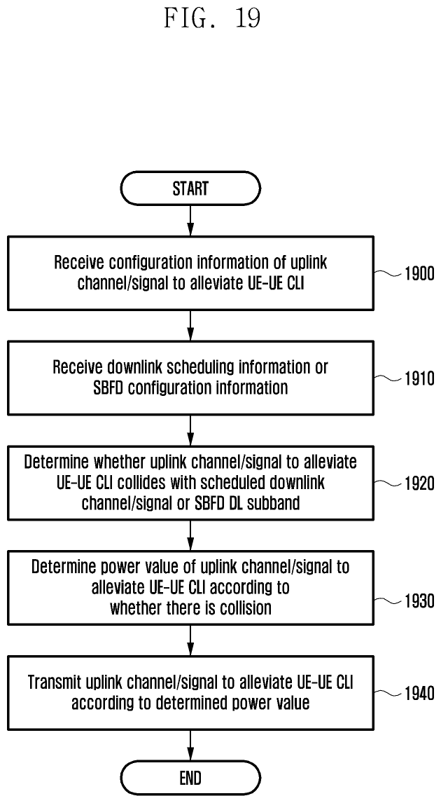

FIG. 19 is a flowchart according to an embodiment of the disclosure.

Referring to FIG. 19, the UE may receive configuration information of an uplink channel and signal to be used for alleviating UE-UE CLI from the base station, at operation 1900. For example, the UE may receive RACH occasion (RO) configuration information from the base station, and ROs according to the configuration may be regarded as uplink channels and signals to be used for alleviating UE-UE CLI. Further, the UE may configure other uplink channels and signals (e.g., configured grant PUSCH, dynamic grant PUSCH, PUCCH, Periodic SRS, Semi-persistent SRS, aperiodic SRS, and the like) as uplink channels and signals to be used for alleviating UE-UE CLI.

The UE may receive downlink scheduling information or SBFD configuration information from the base station, at operation 1910. Here, the scheduled downlink channel and signal may be an SSB, PDSCH, PDCCH, CSI-RS, and the like. For reference, here, the downlink channel and signal may be limited to a specific downlink channel and signal. In this case, the base station to be used in an embodiment of the disclosure may preconfigure a specific downlink channel and signal to the UE through a higher layer signal, or may indicate a specific downlink channel and signal using downlink control information (DCI). SBFD configuration information may include configuration information of an SBFD UL subband or configuration information of an SBFD DL subband.

The UE may determine whether there is a collision between an uplink channel and signal to alleviate UE-UE CLI and a scheduled downlink channel and signal, or an SBFD DL subband, at operation 1920. Here, if the uplink channel and signal and the downlink channel and signal are located in the same symbol in the time domain, the UE may determine it as a collision. As another method, if the uplink channel and signal and the downlink channel and signal are located in the same time interval (e.g., slot) in the time domain, the UE may determine it as a collision. Here, if the uplink channel and signal are located in the SBFD symbol, the UE may determine it as a collision. As another method, if the uplink channel and signal are located in an SBFD slot (a slot in which at least one symbol is an SBFD symbol), the UE may determine it as a collision.

The UE may determine a transmit power value of the uplink channel and signal to alleviate UE-UE CLI according to whether there is a collision, at operation 1930. The UE may determine a transmit power value of the uplink channel and signal to alleviate UE-UE CLI in which no collision has occurred using first maximum transmit power P_{c,max,1}. The UE may determine a transmit power value of an uplink channel and signal in which a collision has occurred using second maximum transmit power P_{c,max,2}. Second maximum transmit power P_{c,max,2} may be characterized as having a lower transmit power value compared to first maximum transmit power P_{c,max,1}.

The UE may transmit an uplink channel/signal to alleviate UE-UE CLI according to the determined transmit power value, at operation 1940. Characteristically, the second maximum transmit power may be 0, and in this case, the UE may not transmit an uplink channel and signal to alleviate UE-UE CLI.

### Embodiment 3 Determination of Maximum Transmit Power According to Priority

In the above-described first and second embodiments, the purpose was to reduce UE-UE CLI to a downlink UE by reducing transmit power of an uplink channel and signal scheduled to the UE. However, in a specific scenario, transmission of the scheduled uplink channel and signal may be more important even if it affects the UE-UE CLI to the downlink UE. Therefore, it may be preferable not to reduce transmit power of the uplink channel and signal according to the situation or the importance of the channel and signal rather than always reducing transmit power of the uplink channel and signal in consideration of UE-UE CLI.

In an embodiment of the disclosure, the UE may configure or indicate a priority to each of the uplink channel and signal and the downlink channel and signal. For reference, according to the NR Rel-16 standard, priorities were configured to each of the uplink channel and signal and the downlink channel and signal. However, according to the above standard, the configured priority was used for determining a priority of channels and signals in the same direction. That is, the UE compared priorities of a first downlink channel and signal and a second downlink channel and signal and received a downlink channel and signal of a high priority. The UE compared priorities of a first uplink channel and signal and a second uplink channel and signal and transmitted an uplink channel and signal of a high priority. However, the above priorities were not applied to channels and signals in different directions. In an embodiment of the disclosure, transmitted and received channels and signals may be determined or transmit power of an uplink channel and signal to be transmitted may be determined based on priorities of channels and signals in different directions.

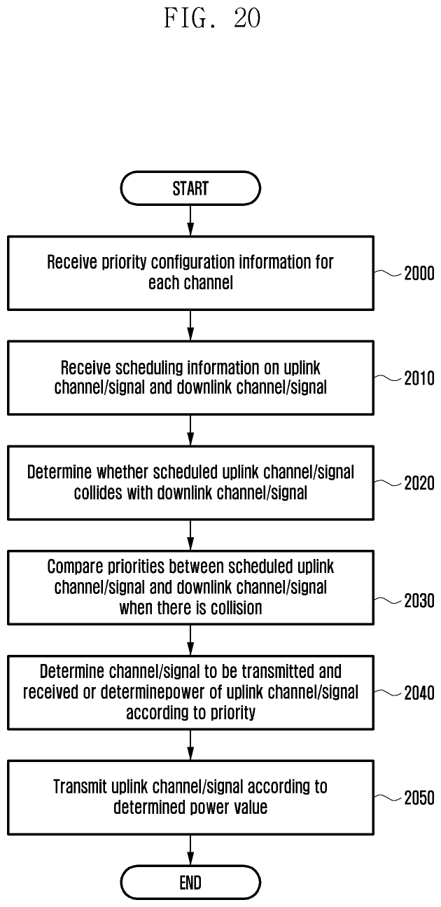

FIG. 20 is a flowchart according to an embodiment of the disclosure.

Referring to FIG. 20, the UE may receive priority configuration information for each channel and signal from the base station through a higher layer signal, at operation 2000. For example, the priority may be two levels. That is, the UE may receive a configuration of one of a high priority and a low priority for each channel and signal. In the case that there is no priority configuration information for a specific channel and signal, a priority of the specific channel and signal may be determined to one of a high priority and a low priority. Preferably, a lower priority may be selected. Preferably, a high priority may be selected for the SSB even without priority configuration information. Preferably, a high priority may be selected for a RACH occasion (RO) even without priority configuration information. Preferably, a high priority may be selected for a PDSCH transmitting an RAR UL grant used for random access, an msg 3 PUSCH, an msg 4 PDSCH, and a PUCCH transmitting HARQ-ACK of the msg 4 PDSCH. Preferably, a low priority may be selected for a PUSCH to PDSCH scheduled to a DCI format 0_0 to a DCI format 1_0. Preferably, a low priority may be selected for channels and signals (at least one of an SPS PDSCH, a CG PUSCH, a periodic CSI-RS, a periodic SRS, or a periodic PUCCH) that are transmitted periodically with a configured period.

For reference, the UE may receive an indication of a priority for each channel and signal from the base station through DCI. In the DCI, there may be a field that may indicate a priority, and a priority of a channel and signal scheduled by the DCI may be indicated through a field that may indicate the priority of the DCI. In the case that the field that may indicate the priority is not included in the DCI, the UE may determine a priority based on priority configuration information configured by the base station through a higher layer signal.

Here, channels and signals may include a PDSCH, PDCCH, CSI-RS, and SSB, which are downlink channels and signals, and uplink channels and signals may include a PUSCH, PUCCH, RACH occasion (PRACH), and SRS. Here, the channel and signal may be a channel and signal scheduled to one UE or a channel and signal scheduled to a plurality of UEs within the cell. For example, the PDCCH, CSI-RS, and SSB detected in a common search space may be channels and signals scheduled to a plurality of UEs in the cell. The RACH occasion (PRACH) may be a channel and signal scheduled to a plurality of UEs within the cell.

The UE may receive scheduling information on an uplink channel and signal and scheduling information on a downlink channel and signal from the base station, at operation 2010. The UE may acquire priorities of the scheduled uplink channel and signal and the scheduled downlink channel and signal. The priority may be acquired from a value configured by a higher layer signal from the base station. The priority may be acquired from a field that may indicate a priority in DCI that schedules the uplink channel and signal or the downlink channel and signal.

The UE may determine whether there is a collision between the scheduled uplink channel and signal and the scheduled downlink channel and signal, at operation 2020. Here, if the uplink channel and signal and the downlink channel and signal are located in the same symbol in the time domain, the UE may determine it as a collision. As another method, if the uplink channel and signal and the downlink channel and signal are located in the same time interval (e.g., slot) in the time domain, the UE may determine it as a collision.

In the case that a collision occurs, the UE may compare a priority of the scheduled uplink channel and signal with that of the scheduled downlink channel and signal, at operation 2030. Through comparison, the UE may determine at least one of the following determinations.
Determination 1: The priority of the uplink channel and signal is lower than that of the downlink channel and signal.
Determination 2: The priority of the uplink channel and signal is the same as that of the downlink channel and signal.
Determination 3: The priority of the uplink channel and signal is higher than that of the downlink channel and signal.

The UE may determine a channel to transmit and receive according to the priority determination. Further, the UE may determine power of the uplink channel or signal according to the priority determination, at operation 2040.

In an embodiment of the disclosure, in the case that a collision occurs, the UE may not transmit a channel or signal of a low priority (in the case that a channel or signal of a low priority is an uplink channel or signal) or may not receive a channel or signal of a low priority (in the case that a channel or signal of a low priority is a downlink channel or signal). That is, in the case of determination 1, because the priority of the uplink channel and signal is lower than that of the downlink channel and signal, the UE may not transmit the uplink channel and signal. In the case of determination 3, because the priority of the downlink channel and signal is lower than that of the uplink channel and signal, the UE may not receive the downlink channel and signal. In the case of determination 2, because the priorities of the uplink channel and signal and the downlink channel and signal are the same, the UE may not determine transmission of one channel based on the priority. In this case, the UE may determine a channel and signal to transmit and receive using at least one of the following methods.
Method 1: The UE may always prioritize one direction. For example, the UE may prioritize uplink transmission. That is, the UE may transmit the scheduled uplink channel and signal, but may not receive the scheduled downlink channel and signal. Conversely, the UE may prioritize downlink transmission. That is, the UE may receive the scheduled downlink channel and signal, but may not transmit the scheduled uplink channel and signal.
Method 2: The UE may determine a priority according to a grant type. For example, in the case that a first channel and signal scheduled to the UE are scheduled through DCI and that a second channel and signal scheduled to the UE are scheduled by a higher layer signal (e.g., SPS PDSCH, CG PUCH, periodic CSI-RS, periodic SRS, and the like), the UE may prioritize the first channel and signal scheduled through DCI. That is, the UE may transmit and receive the first channel and signal (if the first channel and signal are a downlink channel and signal, the UE may receive the downlink channel and signal. If the first channel and signal are an uplink channel and signal, the UE may transmit the uplink channel and signal). The UE may not transmit or receive the second channel and signal.
Method 3: The UE may determine a priority according to whether UE-specific scheduling or cell-common scheduling. For example, in the case that a channel and signal scheduled to the UE are scheduled by cell common scheduling, the UE may prioritize the scheduling. That is, the UE may transmit and receive a cell-common scheduled channel and signal, but may not transmit or receive a UE-specific scheduled channel and signal. Conversely, in the case that a channel and signal scheduled to the UE are scheduled by UE-specific scheduling, the UE may prioritize the scheduling. That is, the UE may transmit and receive a UE-specific scheduled channel and signal, but may not transmit or receive a cell-common scheduled channel and signal. Here, the cell-common scheduled channel may include a PDCCH detected in a common search space (including Type-0 common search space), a PDSCH transmitting SIB, SSB, RACH occasion (PRACH), and the like.

In an embodiment of the disclosure, in the case that a collision occurs, the UE may determine transmit power of the scheduled uplink channel and signal based on the priority.

For example, in the case of determination 1, because the priority of the uplink channel and signal is lower than that of the downlink channel and signal, the UE may determine transmit power of the uplink channel and signal using second maximum transmit power P_{c,max,2}. In the case of determination 3, because the priority of the uplink channel and signal is higher than that of the downlink channel and signal, the UE may determine transmit power of the uplink channel and signal using first maximum transmit power P_{c,max,1}. Here, first maximum transmit power may be characterized as being higher than second maximum transmit power. In the case of determination 2, because the priority of the uplink channel and signal is the same as that of the downlink channel and signal, the UE may determine transmit power of the uplink channel and signal using one of operations of determination 1 to determination 3.

As another example, in the case of determination 1, because the priority of the uplink channel and signal is lower than that of the downlink channel and signal, the UE may lower and transmit power of the uplink channel and signal to a certain level. For example, the UE may reduce transmit power by X dB from the determined transmit power to transmit the uplink channel and signal. Here X is a positive number. Here, X may be a value configured by a higher layer signal from the base station.

The UE may transmit a scheduled uplink channel/signal according to the determined transmit power value, at operation 2050.

### Embodiment 4 Determination of Maximum Transmit Power During Repetition Transmission

The UE may receive a configuration of repetition transmission (PUSCH repetition transmission, PUCCH repetition transmission, or SRS repetition transmission) from the base station. For convenience of description, the description is made based on PUSCH repetition transmission, but the same may be applied to other repetition transmissions.

For PUSCH repetition transmission, the base station may configure the number of repetitions to the UE. The number K of repetitions may be configured by a higher layer signal (RRC signal) from the base station or may be indicated by DCI. The UE may receive DCI scheduling PUSCH repetition. The DCI may include scheduling information on first PUSCH transmission among PUSCH repetition transmissions. The UE may subsequently perform the (K−1) number of PUSCH repetition transmissions based on the first PUSCH transmission. Here, the K number of PUSCHs included in PUSCH repetition transmission may be located in different time domains (e.g., different slots).

The problem to be solved in the disclosure relates to a method of determining transmit power of a PUSCH included in repetition transmission in the case that some PUSCHs of PUSCHs included in repetition transmission collide with a downlink channel and signal, but some other PUSCHs do not collide with a downlink channel and signal.

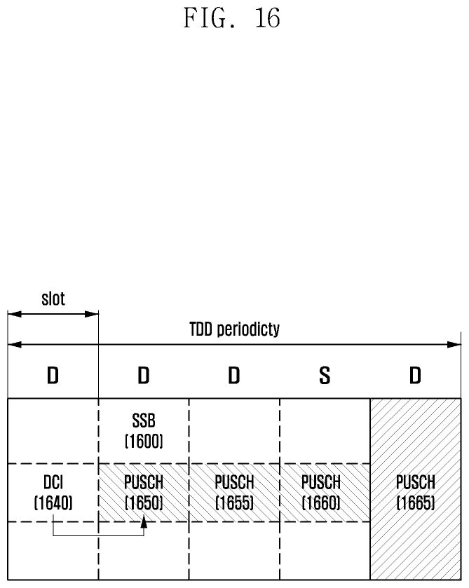

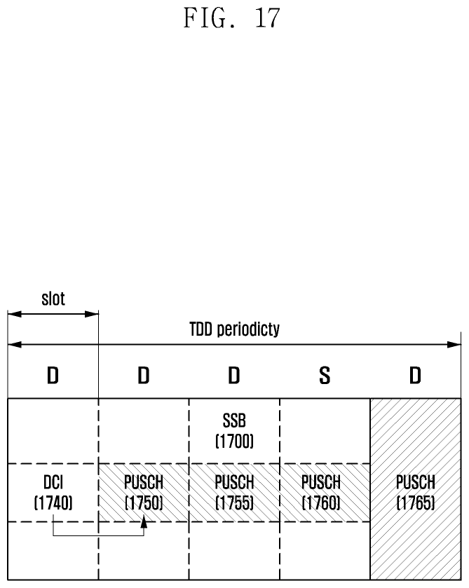

FIGS. 16 and 17 illustrate PUSCH repetition transmission according to various embodiments of the disclosure.

Referring to FIGS. 16 and 17, the UE may be configured to repeat a PUSCH 4 times by the base station. Therefore, a PUSCH scheduled by DCI 1640 and 1740 may be transmitted repeatedly 4 times ({1650, 1655, 1660, 1665}, {1750, 1755, 1760, 1765}). Some PUSCH repetitions 1650 and 1755 of PUSCH repetitions may overlap with SSBs 1600 and 1700. In FIG. 16, first PUSCH repetition 1650 in time may overlap with the SSB 1600, and in FIG. 17, second PUSCH repetition 1755 in time may overlap with the SSB 1700. In FIGS. 16 and 17, the SSB is illustrated as an example of a downlink channel and signal, but the same may be applied even in the case that PUSCH repetition overlaps with other downlink channels and signals other than the SSB.

In an embodiment of the disclosure, the UE may determine transmit power based on one PUSCH repetition and determine equally transmit power for all remaining PUSCH repetitions. Here, one PUSCH repetition may be earliest scheduled PUSCH repetition in time. The UE may determine transmit power of subsequent PUSCH repetitions based on transmit power of first PUSCH repetition, that is, PUSCH repetition scheduled earliest in time. The UE may determine scheduling information on first PUSCH transmission by received DCI. The UE may determine transmit power of the first PUSCH based on the Embodiments 1 to 3. That is, transmit power of the first PUSCH may be determined based on second maximum transmit power P_{c,max,2} if the first PUSCH overlaps with the downlink channel and signal, and be determined based on first maximum transmit power P_{c,max,2} if the first PUSCH does not overlap with the downlink channel and signal. Transmit power of PUSCH repetitions after the first PUSCH may be determined based on the same maximum transmit power. That is, if transmit power of the first PUSCH is determined based on first maximum transmit power, transmit power of PUSCH repetitions after the first PUSCH may be equally determined based on first maximum transmit power. If transmit power of the first PUSCH is determined based on second maximum transmit power, transmit power of PUSCH repetitions after the first PUSCH may be equally determined based on second maximum transmit power.

Referring to FIG. 16, first scheduled PUSCH repetition 1650 collides with the SSB 1600 in the time domain. Therefore, transmit power of first PUSCH repetition may be determined based on second maximum transmit power. Transmit power of subsequent PUSCH repetitions 1655, 1660, and 1665 may be determined based on second maximum transmit power.

Referring to FIG. 17, first scheduled PUSCH repetition 1750 does not collide with the SSB 1700 in the time domain. Therefore, transmit power of the first PUSCH repetition may be determined based on first maximum transmit power. Transmit power of subsequent PUSCH repetitions 1755, 1760, and 1765 may be determined based on first maximum transmit power. Here, the second PUSCH repetition 1755 collides with the SSB in the time domain, but transmit power of the second PUSCH repetition may be determined based on first maximum transmit power.

In an embodiment of the disclosure, the UE may determine transmit power for each PUSCH repetition and determine transmit power of PUSCH repetitions based on lowest transmit power. That is, when transmit power of at least one of the K number of PUSCH repetitions is determined based on second maximum transmit power P_{c,max,2}, transmit power of the K number of PUSCH repetitions may be equally determined based on second maximum transmit power P_{c,max,2}. When transmit power of all PUSCH repetitions among the K number of PUSCH repetitions is determined based on first maximum transmit power P_{c,max,1}, transmit power of the K number of PUSCH repetitions may be equally determined based on first maximum transmit power P_{c,max,1}.

Referring to FIG. 16, the scheduled first PUSCH repetition 1650 collides with the SSB 1600 in the time domain. Accordingly, transmit power of all PUSCH repetitions 1650, 1655, 1660, and 1665 may be determined based on second maximum transmit power.

Referring to FIG. 17, the scheduled second PUSCH repetition 1755 collides with the SSB 1700 in the time domain. Accordingly, transmit power of all PUSCH repetitions 1750, 1755, 1760, and 1765 may be determined based on second maximum transmit power.

In an embodiment of the disclosure, the UE may independently determine transmit power for each PUSCH repetition. The UE may determine transmit power of each PUSCH repetition based on the Embodiments 1 to 3. For example, transmit power of the k-th PUSCH may be determined based on second maximum transmit power P_{c,max,2} if the k-th PUSCH repetition overlaps with the downlink channel and signal, and be determined based on first maximum transmit power P_{c,max,1} if the k-th PUSCH repetition does not overlap with the downlink channel and signal. Transmit power of different PUSCH repetitions may be determined based on different maximum transmit powers.

Referring to FIG. 16, the scheduled first PUSCH repetition 1650 collides with the SSB 1600 in the time domain. Therefore, transmit power of the first PUSCH repetition may be determined based on second maximum transmit power. Because the subsequent PUSCH repetitions 1655, 1660, and 1665 do not collide with the SSB 1600, transmit power thereof may be determined based on first maximum transmit power.

Referring to FIG. 17, the scheduled first, third, and fourth PUSCH repetitions 1750, 1760, and 1765 do not collide with the SSB 1700 in the time domain. Accordingly, transmit power of the first, third, and fourth PUSCH repetitions may be determined based on first maximum transmit power. Because the second PUSCH repetition 1755 collides with the SSB in the time domain, transmit power thereof may be determined based on second maximum transmit power.

In an embodiment of the disclosure, in the case that a plurality of PUSCH repetitions exist within one slot, transmit power of the plurality of PUSCH repetitions may be determined based on the same maximum transmit power. This is to prevent frequent changes in transmit power within a slot by transmitting a plurality of PUSCH repetitions within a slot using the same transmit power. Transmit power of multiple PUSCH repetitions in one slot may be determined based on one PUSCH. The one PUSCH may be earliest PUSCH repetition in time among a plurality of PUSCH repetitions. Maximum transmit power used for PUSCH repetition within one slot may be selected as a lowest value among maximum transmit powers of each PUSCH repetition within one slot. That is, each PUSCH repetition within one slot may independently determine what maximum transmit power will be used. For example, when transmit power of at least one of PUSCH repetitions in one slot is determined based on second maximum transmit power, transmit power of all PUSCH repetitions in the slot is determined based on second maximum transmit power. For example, when transmit power of all PUSCH repetitions in one slot is determined based on first maximum transmit power, transmit power of all PUSCH repetitions in the slot may be determined based on first maximum transmit power.

In an embodiment of the disclosure, the method of determining transmit power of PUSCH repetition described above may not be applied to PUSCH repetition scheduled in a UL symbol (or UL slot). Transmit power of PUSCH repetition scheduled in the UL symbol (or UL slot) may be determined based on first maximum transmit power. In an embodiment, the method of determining transmit power of PUSCH repetition described above may be applied to PUSCH repetition scheduled in a UL symbol (or UL slot).

### Embodiment 5 Determination of Maximum Transmit Power According to Grant

Scheduled uplink channels and signals may be scheduled by DCI or higher layer signals. For example, a dynamic grant (DG) PUSCH may be scheduled, and a PUCCH or aperiodic SRS may be scheduled by DCI. A configured grant (CG) PUSCH may be scheduled, and a periodic SRS may be scheduled by a higher layer signal. The UE may use different maximum transmit power values according to the grant type.

For example, uplink channels and signals scheduled by DCI may always use first maximum transmit power. This is because when the base station schedules by DCI, the base station may schedule to avoid UE-UE CLI affecting a downlink UE. Furthermore, DCI may include an indicator for selecting one of first maximum transmit power and second maximum transmit power. If the DCI indicates first maximum transmit power, an uplink channel and signal scheduled by the DCI may be transmitted based on first maximum transmit power. If the DCI indicates second maximum transmit power, an uplink channel and signal scheduled by the DCI may be transmitted based on second maximum transmit power.

For example, an uplink channel and signal scheduled by a higher layer signal may always use second maximum transmit power. This is because when the base station schedules by a higher layer signal, it is difficult that the base station schedules in consideration of UE-UE CLI affecting a downlink UE. For reference, in an uplink channel and signal scheduled by a higher layer signal, activation DCI may exist. For example, in the case of a type-2 CG PUSCH, activation DCI exists. The activation DCI may include scheduling information on a first CG PUSCH among CG PUSCHs. Accordingly, the first CG PUSCH may use first maximum transmit power, but subsequent CG PUSCHs may use second maximum transmit power.

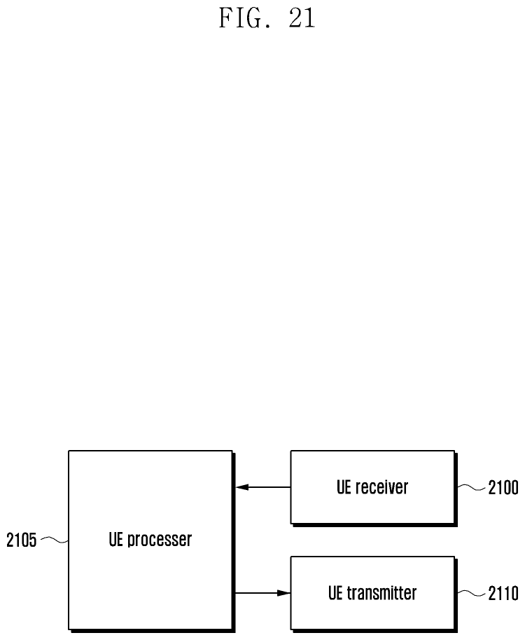

FIG. 21 is a block diagram illustrating a structure of a UE in a wireless communication system according to an embodiment of the disclosure.

Referring to FIG. 21, the UE may include a transceiver referring to a UE receiver 2100 and a UE transmitter 2110, memory (not illustrated), and a UE processer 2105 (or UE controller or processor). According to a communication method of the above-described UE, the UE receiver 2100 and UE transmitter 2110, the memory, and the UE processer 2105 may operate. However, the components of the UE are not limited to the examples described above. For example, the UE may include more or fewer components than the above-described components. Further, the transceiver, the memory, and the processor may be implemented in the form of a single chip.

The transceiver may transmit and receive a signal to and from the base station. Here, the signal may include control information and data. To this end, the transceiver may include an RF transmitter for up-converting and amplifying a frequency of a signal to be transmitted, and an RF receiver for amplifying the received signal with low noise and down-converting a frequency thereof. However, this is only an example of the transceiver, and the components of the transceiver are not limited to the RF transmitter and the RF receiver.

Further, the transceiver may receive a signal through a wireless channel, output the signal to the processor, and transmit the signal output from the processor through the wireless channel.

The memory may store programs and data necessary for an operation of the UE. Further, the memory may store control information or data included in signals transmitted and received by the UE. The memory may be composed of storage media such as read only memory (ROM), random an access memory (RAM), a hard disk, a compact disc-ROM (CD-ROM), and a digital versatile disc (DVD), or a combination of storage media. Further, there may be a plurality of memories.

Further, the processor may control a series of processes so that the UE may operate according to the above-described embodiment. For example, the processor may receive DCI composed of two layers and control components of the UE to simultaneously receive multiple PDSCHs. There may be a plurality of processors, and the processor may execute a program stored in the memory to perform a component control operation of the UE.

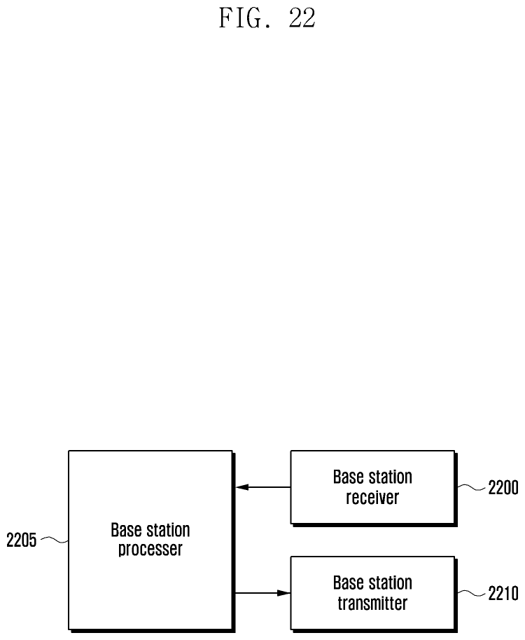

FIG. 22 is a block diagram illustrating a structure of a base station in a wireless communication system according to an embodiment of the disclosure.

Referring to FIG. 22, the base station may include a transceiver referring to a base station receiver 2200 and a base station transmitter 2210, memory (not illustrated), and a base station processer 2205 (or base station controller or processor). According to a communication method of the above-described base station, the base station receiver 2200 and base station transmitter 2210, the memory, and the base station processer 2205 may operate. However, the components of the base station are not limited to the above examples. For example, the base station may include more or fewer components than the above-described components. Further, the transceiver, the memory, and the processor may be implemented in the form of a single chip.

The transceiver may transmit and receive a signal to and from the UE. Here, the signal may include control information and data. To this end, the transceiver may include an RF transmitter for up-converting and amplifying a frequency of a signal to be transmitted, and an RF receiver for amplifying the received signal with low noise and down-converting a frequency thereof. However, this is only an example of the transceiver, and the components of the transceiver are not limited to the RF transmitter and the RF receiver.

Further, the transceiver may receive a signal through a wireless channel, output the signal to the processor, and transmit the signal output from the processor through the wireless channel.

The memory may store programs and data necessary for an operation of the base station. Further, the memory may store control information or data included in signals transmitted and received by the base station. The memory may be composed of storage media such as a ROM, a RAM, a hard disk, a CD-ROM, and a DVD, or a combination of storage media. Further, there may be multiple memories.

The processor may control a series of processes so that the base station may operate according to the above-described embodiment of the disclosure. For example, the processor may constitute two layers of DCI including allocation information on multiple PDSCHs and control each component of the base station so as to transmit them. There may be a plurality of processors, and the processor may execute a program stored in the memory to perform a component control operation of the base station.

Methods according to the embodiments described in the claims or specifications of the disclosure may be implemented in the form of hardware, software, or a combination of hardware and software.

In the case of being implemented in software, a computer readable storage medium storing one or more programs (software modules) may be provided. One or more programs stored in the computer readable storage medium are configured for execution by one or more processors in an electronic device. The one or more programs include instructions for causing an electronic device to execute methods according to embodiments described in a claim or specification of the disclosure.

Such programs (software modules, software) may be stored in random access memory, non-volatile memory including flash memory, read only memory (ROM), an electrically erasable programmable ROM (EEPROM), a magnetic disc storage device, a compact disc-ROM (CD-ROM), digital versatile discs (DVDs), any other form of optical storage device, or a magnetic cassette. Alternatively, the programs may be stored in memory composed of a combination of some or all thereof. Further, each configuration memory may be included in the plural.

Further, the program may be stored in an attachable storage device that may access through a communication network such as the Internet, Intranet, local area network (LAN), wide LAN (WLAN), or storage area Network (SAN), or a communication network composed of a combination thereof. Such a storage device may access to a device implementing an embodiment of the disclosure through an external port. Further, a separate storage device on a communication network may access to a device implementing the embodiment of the disclosure.

In the specific embodiments of the disclosure described above, elements included in the disclosure are expressed in the singular or plural according to the specific embodiments presented. However, the singular or plural expression is appropriately selected for a situation presented for convenience of description, and the disclosure is not limited to the singular or plural components, and even if a component is represented in the plural, it may be composed of the singular, or even if a component is represented in the singular, it may be composed of the plural.

Embodiments of the disclosure disclosed in this specification and drawings merely present specific examples in order to easily describe the technical contents of the disclosure and help the understanding of the disclosure, and they are not intended to limit the scope of the disclosure. That is, it will be apparent to those of ordinary skill in the art to which the disclosure pertains that other modifications based on the technical spirit of the disclosure may be implemented. Further, each of the above embodiments may be operated in combination with each other, as needed. For example, the base station and the UE may be operated by combining parts of an embodiment and another embodiment of the disclosure with each other. For example, the base station and the UE may be operated by combining parts of Embodiments 1 and 5 of the disclosure with each other. Further, although the above embodiments have been presented based on an FDD LTE system, other modifications based on the technical idea of the embodiment may be implemented in other systems such as a TDD LTE system, 5G or NR system.

In the drawings for describing the method of the disclosure, the order of description does not necessarily correspond to the order of execution, and the precedence relationship may be changed or may be executed in parallel.

Alternatively, the drawings illustrating the method of the disclosure may omit some components and include only some components within the scope that does not impair the essence of the disclosure.

Further, the method of the disclosure may be implemented in a combination of some or all of the contents included in each embodiment within a range that does not impair the essence of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a communication system, the method comprising:
receiving, from a base station, information for a downlink channel or a downlink signal;
receiving, from the base station, information for an uplink channel or an uplink signal;
determining transmission power for the uplink channel or the uplink signal; and
transmitting, to the base station, the uplink channel or the uplink signal based on the transmission power,
wherein the transmission power for the uplink channel or the uplink signal is determined as a first transmission power in case that the downlink channel or the downlink signal does not overlap with the uplink channel or the uplink signal,
wherein the transmission power for the uplink channel or the uplink signal is determined as a second transmission power in case that the downlink channel or the downlink signal overlaps with the uplink channel or the uplink signal, and
wherein the second transmission power is less than or equal to the first transmission power.

2. The method of claim 1, wherein:
the second transmission power is less than or equal to the first transmission power by a predetermined value; or
the second transmission power is based on a second maximum transmission power for the second transmission power that is less than or equal to a first maximum transmission power for the first transmission power.

3. The method of claim 1, wherein the uplink channel or the uplink signal corresponds to a physical random access channel (PRACH), and a maximum transmission power for the second transmission power is configured for each PRACH occasion (RO).

4. The method of claim 1, wherein the transmission power for the uplink channel or the uplink signal is determined based on a priority of the downlink channel or the downlink signal, and a priority of the uplink channel or the uplink signal.

5. The method of claim 1, wherein, in case that the uplink channel or the uplink signal is with repetitions, the transmission power for the repetitions is determined based on:
a transmission power for a first repetition among the repetitions;
a transmission power for a repetition having a lowest transmission power among the repetitions; or
a transmission power determined for each repetition.

6. The method of claim 1, wherein the transmission power is determined according to whether the uplink channel or the uplink signal is based on a dynamic grant or a configured grant.

7. A user equipment (UE) in a communication system, the UE comprising:
a transceiver; and
a controller configured to:
receive, from a base station, information for a downlink channel or a downlink signal,
receive, from the base station, information for an uplink channel or an uplink signal,
determine transmission power for the uplink channel or the uplink signal, and
transmit, to the base station, the uplink channel or the uplink signal based on the transmission power,
wherein the transmission power for the uplink channel or the uplink signal is determined as a first transmission power in case that the downlink channel or the downlink signal does not overlap with the uplink channel or the uplink signal,
wherein the transmission power for the uplink channel or the uplink signal is determined as a second transmission power in case that the downlink channel or the downlink signal overlaps with the uplink channel or the uplink signal, and
wherein the second transmission power is less than or equal to the first transmission power.

8. The UE of claim 7, wherein:
the second transmission power is less than or equal to the first transmission power by a predetermined value; or
the second transmission power is based on a second maximum transmission power for the second transmission power that is less than or equal to a first maximum transmission power for the first transmission power.

9. The UE of claim 7, wherein the uplink channel or the uplink signal corresponds to a physical random access channel (PRACH), and a maximum transmission power for the second transmission power is configured for each PRACH occasion (RO).

10. The UE of claim 7, wherein the transmission power for the uplink channel or the uplink signal is determined based on a priority of the downlink channel or the downlink signal, and a priority of the uplink channel or the uplink signal.

11. The UE of claim 7, wherein, in case that the uplink channel or the uplink signal is with repetitions, the transmission power for the repetitions is determined based on:
a transmission power for a first repetition among the repetitions;
a transmission power for a repetition having a lowest transmission power among the repetitions; or
a transmission power determined for each repetition.

12. The UE of claim 7, wherein the transmission power is determined according to whether the uplink channel or the uplink signal is based on a dynamic grant or a configured grant.

13. A method performed by a base station in a communication system, the method comprising:
transmitting, to a user equipment (UE), information for a downlink channel or a downlink signal;
transmitting, to the UE, information for an uplink channel or an uplink signal; and
receiving, from the UE, the uplink channel or the uplink signal associated with a transmission power for the uplink channel or the uplink signal,
wherein the transmission power for the uplink channel or the uplink signal is a first transmission power in case that the downlink channel or the downlink signal does not overlap with the uplink channel or the uplink signal,
wherein the transmission power for the uplink channel or the uplink signal is a second transmission power in case that the downlink channel or the downlink signal overlaps with the uplink channel or the uplink signal, and
wherein the second transmission power is less than or equal to the first transmission power.

14. The method of claim 13, wherein:
the second transmission power is less than or equal to the first transmission power by a predetermined value; or
the second transmission power is based on a second maximum transmission power for the second transmission power that is less than or equal to a first maximum transmission power for the first transmission power.

15. The method of claim 13, wherein the uplink channel or the uplink signal corresponds to a physical random access channel (PRACH), and a maximum transmission power for the second transmission power is configured for each PRACH occasion (RO).

16. The method of claim 13, wherein the transmission power for the uplink channel or the uplink signal is based on a priority of the downlink channel or the downlink signal, and a priority of the uplink channel or the uplink signal.

17. A base station in a communication system, the base station comprising:
a transceiver; and
a controller configured to:
transmit, to a user equipment (UE), information for a downlink channel or a downlink signal;
transmit, to the UE, information for an uplink channel or an uplink signal; and
receive, from the UE, the uplink channel or the uplink signal associated with a transmission power for the uplink channel or the uplink signal,
wherein the transmission power for the uplink channel or the uplink signal is a first transmission power in case that the downlink channel or the downlink signal does not overlap with the uplink channel or the uplink signal,
wherein the transmission power for the uplink channel or the uplink signal is a second transmission power in case that the downlink channel or the downlink signal overlaps with the uplink channel or the uplink signal, and
wherein the second transmission power is less than or equal to the first transmission power.

18. The base station of claim 17, wherein:
the second transmission power is less than or equal to the first transmission power by a predetermined value; or
the second transmission power is based on a second maximum transmission power for the second transmission power that is less than or equal to a first maximum transmission power for the first transmission power.

19. The base station of claim 17, wherein the uplink channel or the uplink signal corresponds to a physical random access channel (PRACH), and a maximum transmission power for the second transmission power is configured for each PRACH occasion (RO).

20. The base station of claim 17, wherein the transmission power for the uplink channel or the uplink signal is based on a priority of the downlink channel or the downlink signal, and a priority of the uplink channel or the uplink signal.
